(19) United States
(12) Patent Application Publication
(10) Pub. No.: US 2025/0111566 A1
(43) Pub. Date: Apr. 3, 2025

(54) SURROGATE CURVATURES FOR ASSISTED VECTOR DESIGNS

(71) Applicant: Adobe Inc., San Jose, CA (US)

(72) Inventors: Vivek Agrawal, Noida (IN); Tarun Beri, Noida (IN)

(73) Assignee: Adobe Inc., San Jose, CA (US)

(21) Appl. No.: 18/479,439

(22) Filed: Oct. 2, 2023

(51) Int. Cl. G06T 11/60; G06T 11/20

(52) U.S. Cl. CPC G06T 11/60; G06T 11/203

(57) ABSTRACT

In implementations of systems and procedures for generating surrogate curvatures for assisted vector drawings, a computing device implements acquisition of a target vector curve and compares a curvature of the target vector curve to a curvature of a reference vector curve. The computing device determines whether the curvature of the target vector curve is within a threshold tolerance of the curvature of the reference vector curve. An edited curvature of the targeted vector curve is generated based on the curvature of the reference vector curve.

### BACKGROUND

In a computer graphics software environment, tools for controlling and manipulating the vertices and control handles of Bezier curves support user inputs to directly generate or modify vector artwork according to user preferences. Such vector artwork often includes simple illustrations formed from a few Bezier curves which connect to form complex vector paths, or complex illustrations including multiple vector paths formed from tens or hundreds of Bezier curves.

However, conventional techniques do not support an ability to harmonize vector paths within a vector artwork. Rather, conventional techniques rely on manual inputs which are prone to error and as such result in inefficient use of computational resources and power consumption.

### SUMMARY

Surrogate curvatures techniques are described that support assisted vector designs. As an example, within a computer graphics environment, a curvature of a target vector curve is determined. The curvature is compared to curvatures of other vector curves within the environment, and a determination is made as to whether the curvature of the target vector curve is similar to curvatures of one or more of the other curves. A curve guide is output, in one or more examples, to indicate the amount of similarity between the curvature of the target vector curve and the other curves. An edited curvature, referred to as a surrogate curvature, of the target vector curve is generated based on similarity between the curvature of the target vector curve and the curvature of one or more of the other curves. The edited curvature, when applied to the target vector curve, modifies the target vector curve to have a corresponding curvature as one or more of the other curves.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ surrogate curvatures for assisted vector designs as described herein.

FIG. 2 depicts an example implementation showing operation of the curvature system of FIG. 1 in greater detail.

FIG. 3 depicts a system showing operation of a curve input module and a signature generation module of FIG. 2 in greater detail.

FIG. 4 depicts a system showing operation of a curvature comparison module of FIG. 2 in greater detail.

FIGS. 5A-5B show a flow diagram depicting a procedure in an example implementation in which an edited curvature of a target vector curve is generated based on a curvature of a reference vector curve.

FIG. 6 shows a flow diagram depicting a procedure in an example implementation which includes determining a curvature of a target vector curve and a curvature of a reference vector curve.

FIG. 7 illustrates an example of vector graphic content of a digital image including multiple vector curves.

FIG. 8 illustrates a first modification of the vector graphic content of FIG. 7 using surrogate curvatures.

FIG. 9 illustrates a second modification of the vector graphic content of FIGS. 7-8 using surrogate curvatures.

FIG. 10 illustrates another example of vector graphic content of a digital image including multiple vector curves.

FIG. 11 illustrates a first modification of the vector graphic content of FIG. 10 without using surrogate curvatures.

FIG. 12 illustrates a second modification of the vector graphic content of FIGS. 10-11 without using surrogate curvatures.

FIG. 13 illustrates a third modification of the vector graphic content of FIGS. 10-12 using surrogate curvatures.

FIG. 14 illustrates an example of a vector curve formed from multiple connected Bezier curves.

FIG. 15 illustrates an example of a first vector curve and a second vector curve each formed from multiple Bezier curves, with a curvature of the first vector curve modified to match a curvature of the second vector curve using surrogate curvatures.

FIG. 16 illustrates an example of partitioning of a Bezier curve.

FIG. 17 illustrates an example system that includes an example computing device that is representative of one or more computing systems and/or devices for implementing the various techniques described herein.

### DETAILED DESCRIPTION

### Overview

Digital images are configurable to include vector paths forming curves. Often, such curves are independently adjustable via user input in a computer graphics environment, e.g., using a digital image editing application. These environments support a wide variety of adjustments of curves of digital images, such as adjustments to curve position, scale, orientation, and so on.

Some curves included by digital images are definable as Bezier curves. A Bezier curve is configurable by a pair of vertices and at least one control handle, with the relative positions of the vertices and control handle defining a curvature of the curve. A vector path may include multiple curves, and the curves are connected in some instances to support complex curvatures of the vector path. Thus, vector paths including curves are used to form a variety of different shapes for typefaces, illustration, and so forth.

Often, a digital image including vector graphic content includes hundreds or thousands of vector paths, and each vector path is configurable to include multiple curves. In conventional techniques, it is often difficult to visually compare vector paths to each other, e.g., to determine visual similarity between the vector paths. Comparison is difficult because vector paths are often generated independently of each other, are independently adjustable, are configurable to overlap and intersect each other, are configurable with different curvatures, have different lengths, and so on.

Consider a digital image, for instance, including a first vector path and a second vector path. During the generation or adjustment of the vector paths, a creative professional visually compares the second vector path to the first vector path and wishes to match a curvature of the second vector path with the curvature of the first vector path. One conventional approach includes manual adjustment of a position of vertices and/or control handles of the second vector path (e.g., via user input) to adjust the curvature of the second vector path. However, manual adjustment relies on visual approximation of the curvatures by a human being, e.g., an artist. It is difficult in real world scenarios, though, for a human being to visually approximate the curvatures, particularly when a digital image includes multiple vector paths. Such approaches often lead to undesired vector path asymmetry, imprecise curvatures, increased consumption of computational resources, increased power consumption, and reduced user-friendliness.

Accordingly, surrogate curvature techniques are described that support correspondence between curvatures that is leveraged as part of digital content creation. The curvatures of different vector paths within a digital image, for instance, are determined (e.g., measured) and compared to each other such that a curvature of a first path is used as a basis to edit a second path, e.g., to promote visual similarity of the paths automatically and without user intervention.

Consider a scenario in which a creative professional is tasked with designing a logo. To do so, the creative professional designs the logo such that curves used to form the logo have a curvature that is visually consistent with each other. In conventional systems, the creative professional is tasked with manual alignment of the curvatures, which is inaccurate and frequently encounters errors. In the techniques described herein, however, the curvature system is configured to support edits to curves, automatically and without user intervention, based on curvature of one or more other curves in the digital content. Consequently, the techniques described herein improve operation of computing devices that implement these techniques and reduce power consumption through this improved operation.

In the scenario of designing the logo, the creative professional selects a curve within a digital image, e.g., an outer edge of the logo. The curvature system compares the curvature of the selected curve to the curvature of other curves within the digital image, e.g., inner edges of the logo. While the curve is selected, curve guides are displayed, automatically and without user intervention by the curvature system, indicating similarity between the selected curve and the other curves. The curve guides are continuously updated by the curvature system throughout modification of the selected curve to reflect which other curves within the digital image have similar curvatures.

In one or more implementations, a curvature system is employed to increase an ease and precision of matching the curvatures of curves within a digital image by performing comparison and matching of the curvatures automatically based on measured characteristics of the curves. For example, the curvature system defines a curve signature for each curve within a digital image, with the curve signature of a curve indicating the particular curvature of that curve using sequences of text. The curve signatures defined by the curvature system are compared to each other to determine whether curves within a digital image are within a threshold amount of similarity to each other, as well as the amount of similarity between the curves. The curvature system is further operable to generate edited curvatures to facilitate matching of curvatures between curves.

When the curvature of the selected curve is sufficiently similar to the curvature of another curve within the digital image (e.g., within a defined threshold amount), for instance, the curvature system is operable to update the selected curve with an edited curvature based on the other curve, e.g., a surrogate curvature. In this way, curvatures of curves within the digital image may be easily matched to each other, e.g., to quickly match the curvatures of outer edges of the logo to the curvatures of inner edges of the logo. As a result, a precision and ease of adjustment of the curvatures is increased, which may increase a productivity of the creative professional.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Surrogate Curvature Environment

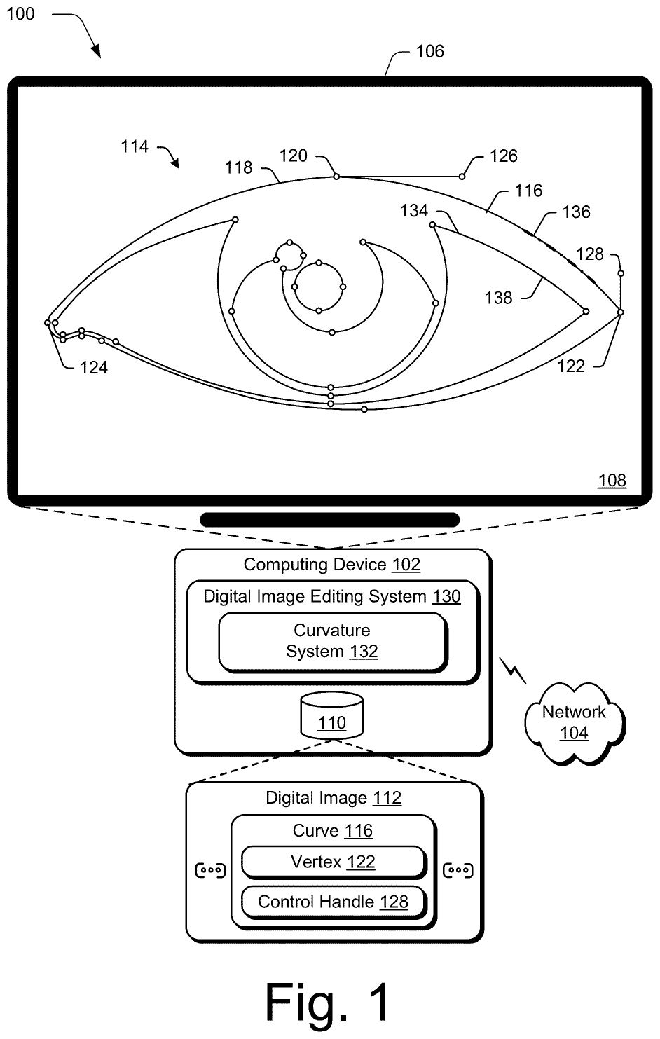

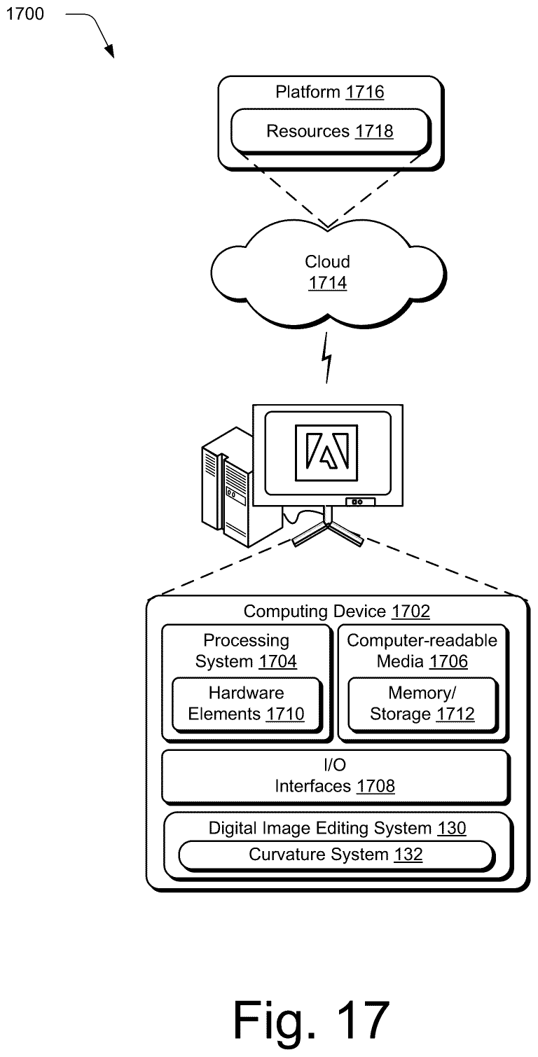

FIG. 1 is an illustration of an environment 100 in an example implementation that is operable to employ surrogate curvature techniques for assisted vector designs as described herein. The illustrated environment 100 includes a computing device 102. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources, such as a personal computer, game console, etc., to a low-resource device with limited memory and/or processing resources, such as a mobile device. The computing device 102 is configurable to connect to a network 104, e.g., to support electronic communication between the computing device 102 and other electronic devices external to the computing device 102. In some examples, the computing device 102 is representative of a plurality of different devices such as multiple servers utilized to perform operations “over the cloud” as further described in relation to FIG. 17.

The illustrated environment 100 also includes a display device 106 that is communicatively coupled to the computing device 102 via a wired or a wireless connection. The display device 106 is configured to output a user interface 108. A variety of device configurations are usable to implement the computing device 102 and/or the display device 106.

The computing device 102 includes a storage device 110. The storage device 110 supports electronic storage of digital content such as digital images, digital artwork, digital videos, etc. For instance, the storage device 110 is configurable as non-transitory computer memory, such as a computer hard disk drive or solid state drive. In the illustrated example, storage device 110 includes a digital image 112 stored thereon. The digital image is configurable in a variety of ways according to a variety of formats, such as an SVG, EPS, JPEG, PNG, bitmap, and so on.

The computing device 102 also includes a digital image editing system 130. The digital image editing system 130 is configured to provide a digital environment (e.g., a user interface 108) supporting the creation, display, and/or manipulation of the digital image 112. Digital image editing system 130 is configurable to operate on digital images including vector graphic content such as vector curves. In some instances, digital image editing system 130 further supports operation on digital images including raster graphic content, such as photographs, and/or a mix of vector graphic content and raster graphic content. The digital image editing system 130 provides digital tools via the user interface 108 for manipulation of vector graphic content, such as vertex movement tools, vector path segmentation tools, and so forth. The digital image editing system 130 further provides digital tools for generation of vector graphic content, such as shape generation tools, typeface tools, and so forth.

In an implementation, the digital image 112 includes vector graphic content. The digital image 112 is provided to the digital image editing system 130, e.g., opened within the digital image editing system 130 by loading the digital image 112 into the digital image editing system 130 from storage device 110. The digital image editing system 130 then displays the digital image 112 (including the vector graphic content) at the display device 106 via the user interface 108. In the illustrated example of FIG. 1, the digital image 112 includes vector content 114 illustrating a representation of a human eye. The vector content 114 is editable via the digital image editing system 130, e.g., for adjustment of the appearance of the human.

As previously described, conventional techniques rely on human interaction to manually adjust curves for visual consistency, and therefore are prone to error, result in inefficient use of computational resources and increased power consumption. Accordingly, digital image editing system 130 additionally supports functionality represented as a curvature system 132 involving the comparison and editing of curves included in the digital image 112.

The curvature system 132, for instance, is embedded within the digital image editing system 130, e.g., stored as instructions within the digital image editing system 130 that are executable by the digital image editing system 130. The curvature system 132 is configured to perform operations described herein relating to the comparing and editing of curvatures of curves within digital images. Such operations supported by curvature system 132 include comparing curvatures of vector curves, generating curve signatures of vector curves, generating edited curvatures of vector curves, and so forth, according to the procedures described further below.

By configuring the digital image editing system 130 to include the curvature system 132, a variety of functionality is realized that is not found in conventional approaches to digital image editing. For instance, digital images often include representations of organic forms such as human hands, animals, plants, and so forth, and/or abstractions or symbols such as icons, typeface letters, logos, and the like. Such digital images often include curves representing said features. The curvature system 132 supports comparison and editing of the curvatures of such curves, and as a result, the curvature system 132 increases an ease of modification and creation of digital images including vector graphic content.

Consider, for example, a digital image including a representation of a human eye, such as the digital image 112 depicted in FIG. 1. The human eye includes curves defining the upper and lower eyelids, the iris, the pupil, and so forth. Actual human eyes often exhibit curvatures with similarity across various features, e.g., upper eyelids and lower eyelids are often observed having similar curvatures. Therefore, in representations of human eyes, such as the representation included by digital image 112, it is often desirable to represent such features with curves having corresponding curvatures. However, achieving corresponding curvature between different curves presents challenges with conventional digital image editing approaches.

For example, in using conventional approaches to create a representation of a human eye with curves in a digital image, a creative professional represents an upper edge of the upper eyelid with a first curve. Subsequently, a lower edge of the lower eyelid is represented with a second curve. For a realistic portrayal of the eye, the creative professional is tasked with matching the curvature of the curve defining the lower edge to the curvature of the curve defining the upper edge. However, conventional approaches utilize manual adjustment of the curvatures of the curves, e.g., the curvature of the curve defining the lower edge. Adjusting the curvatures manually according to conventional approaches in real world scenarios introduces curvature irregularities and imprecision, as the adjustments rely on visual approximation of the curvatures and are prone to human error.

According to the techniques and procedures described herein, however, such irregularities and imprecisions associated with manual adjustment of curvatures are reduced or obviated. The curvature system 132 included by the digital image editing system 130 increases an ease and precision of matching the curvatures of curves within a digital image by performing comparison and matching of the curvatures automatically based on measured characteristics of the curves. For example, the curvature system 132 defines a curve signature for each curve within a digital image, with the curve signature of a curve indicating the particular curvature of that curve. The curve signatures defined by the curvature system 132 are compared to each other to determine whether curves within a digital image are with a threshold amount of similarity to each other, as well as the amount of similarity between the curves. The curvature system 132 is further operable to generate edited curvatures to facilitate matching of curvatures between curves.

In an example operation of the configuration shown by FIG. 1, the digital image 112 includes a plurality of curves, such as curve 116, with curve 116 being a portion of the vector graphic content of the digital image 112. Each curve, such as the curve 116, is definable by a plurality of vertices, such as vertex 122. Each curve is further definable by one or more control handles, such as control handle 128. The vertices and control handles define the curvature of the curves, and during some operations performed via digital image editing system 130, at least some of the vertices and control handles are displayed by the digital image editing system 130 at display device 106.

The vector content 114 of the digital image 112 includes vertex 124, vertex 120, and vertex 122, among others. The vertices define vector curves representing features portrayed by the digital image 112. For example, vector curve 118 is shown defined by each of vertex 124 and vertex 120, and vector curve 116 is shown defined by each of vertex 120 and vertex 122. Vector curve 116 and vector curve 118 are each definable as Bezier curves. The vector curve 116 is shown further defined by each of control handle 126 and control handle 128. The position of control handle 126 defines the direction at which vector curve 116 curves toward the vertex 120, and the position of control handle 128 defines the direction at which vector curve 116 curves toward vertex 122. Thus, the curvature of vector curve 116 is definable by vertex 120 in combination with control handle 126, and by vertex 122 in combination with control handle 128.

A user input is then received via the user interface 108 to select and modify curvature of vector curve 116. In performing the modification, the vector curve 116 is selected. Selection of a curve is referred to herein as targeting, and selected curves are referred to as targeted curves and/or target vector curves. In some examples, selection is performed via user input applied through the user interface 108 of the digital image editing system 130, e.g., using a cursor control device, gesture, spoken utterance, and so forth.

In response, the curvature system 132 generates a curvature signature of the vector curve 116 and a respective curvature signature for each other vector curve within the vector content 114. The curvature system 132, for instance, generates curvature signatures for the vector curve 134 representing a lower edge of the upper eyelid of the eye depicted by vector content 114. The curvature system 132 compares the curvature signatures to determine similarity between the various curves. In the example shown, vector curve 116 is selected, as described above. Responsive to the selection, the curvature system 132 determines that a portion of the curvature of the vector curve 116 is similar to a portion of the vector curve 134. As a result, the curvature system 132 displays a first curve guide 136 and a second curve guide 138, with the first curve guide 136 and the second curve guide 138 indicating the portion of the curvature of the vector curve 116 and the portion of the curvature of the vector curve 134, respectively. In the example shown, the curve guides are illustrated with dash-dot broken lines.

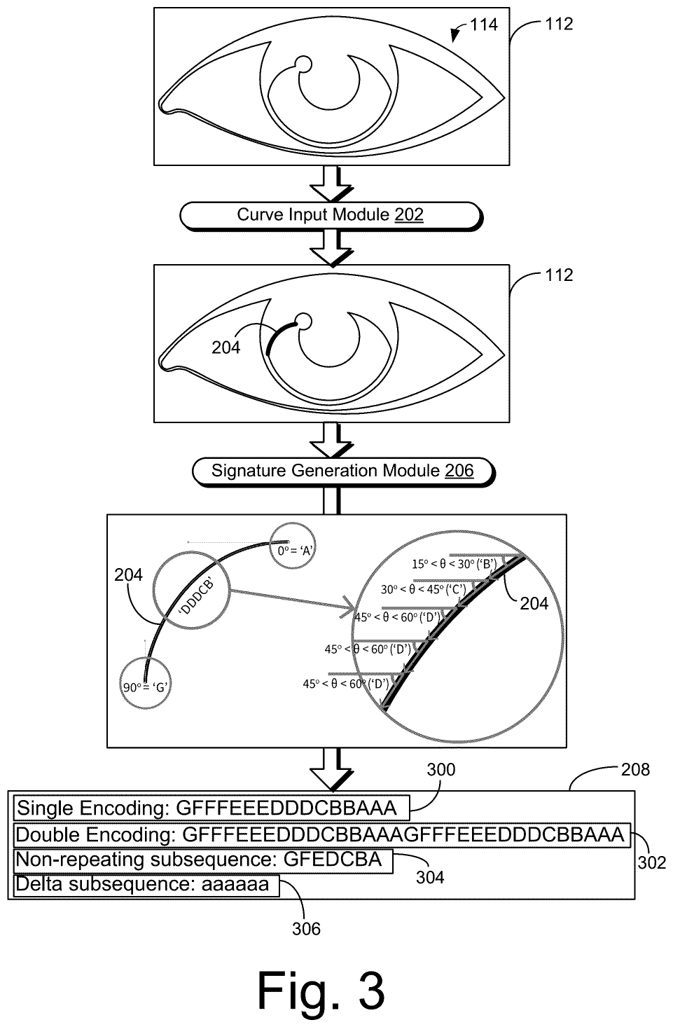

In some instances, the curvature system 132 generates an edited curvature of a curve based on the curvatures of other curves within a digital image. In the example of the digital image 112, generation is performed while the vector curve 116 is selected. The curvature system 132 determines the curvature of the vector curve 116 is within a threshold amount of similarity to curvature of another vector curve within the digital image 112, e.g., using signatures as described in relation to FIG. 3. In response, the curvature system 132 is operable to replace the curvature of the selected curve with the curvature of another curve within the digital image, e.g., a surrogate curvature. The curvature system 132 determines whether curves are within a threshold amount of similarity based on a pre-determined curvature difference tolerance. In this way, the curvature system 132 facilitates improved user interaction in modifying curves to have corresponding curvatures with increased precision. Further description of these and other examples is included in the following discussion and shown using corresponding figures.

In the following discussion, example environments are described that employ the techniques described herein. Example procedures are also described that are performable in the example environments as well as other environments. Consequently, performance of the example procedures is not limited to the example environments and the example environments are not limited to performance of the example procedures.

### Curvature System

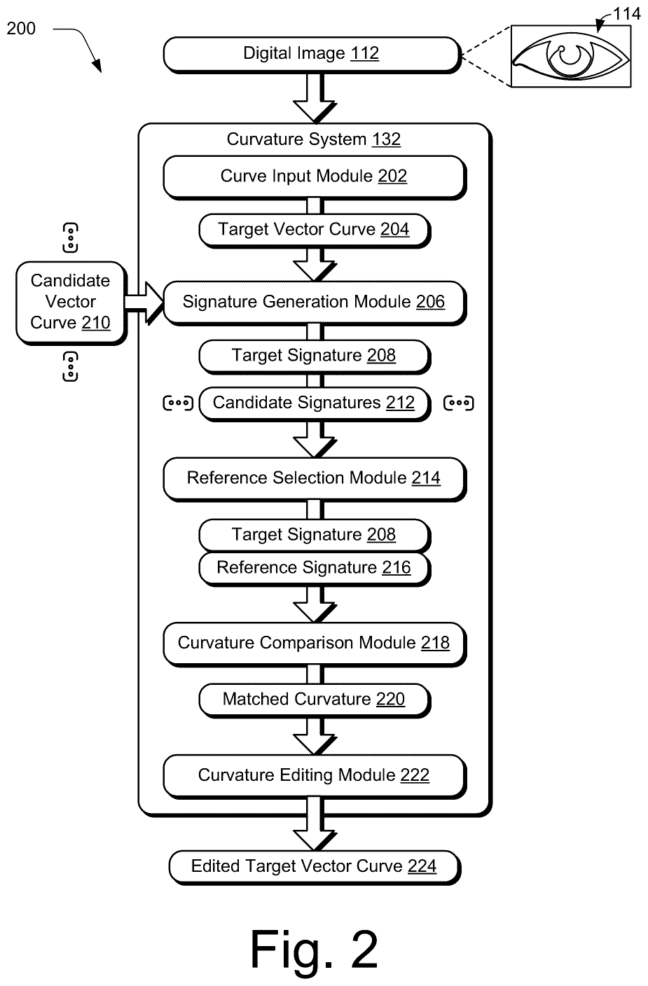

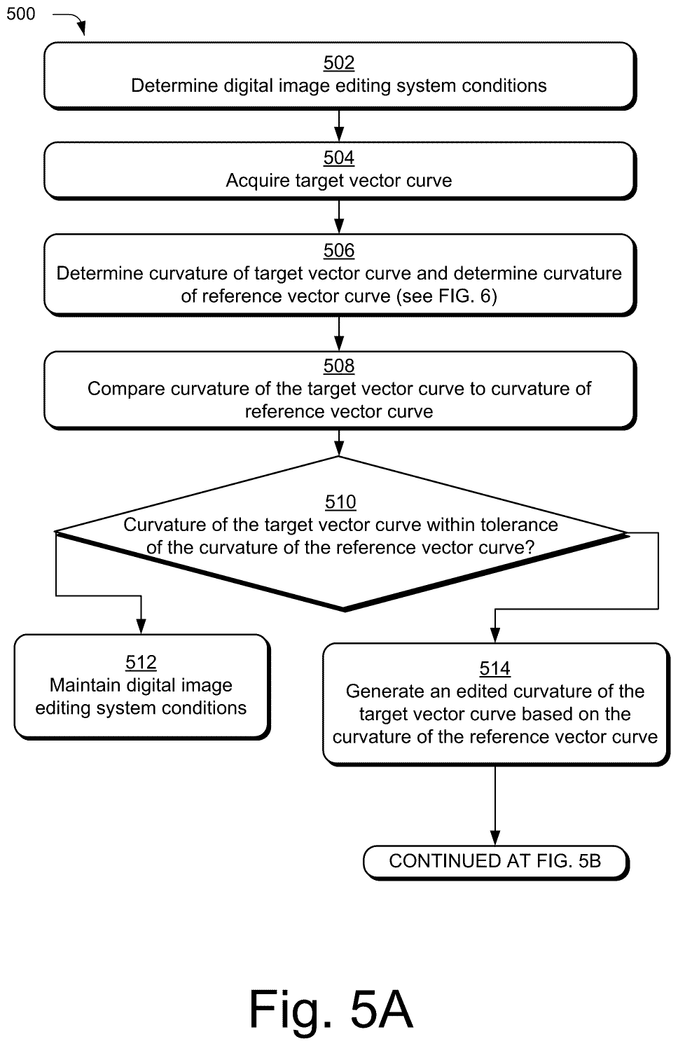

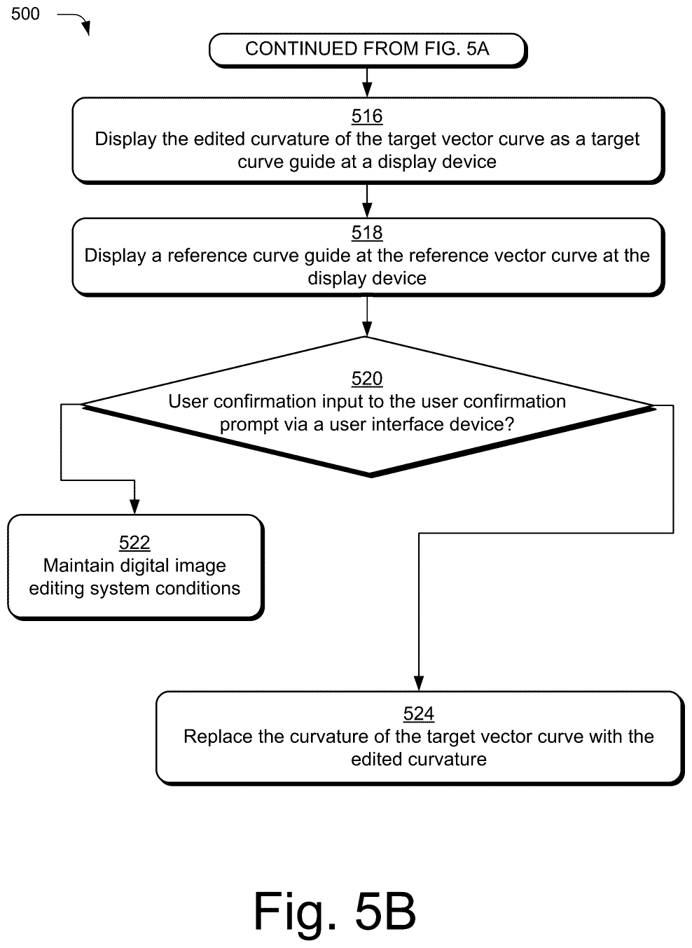

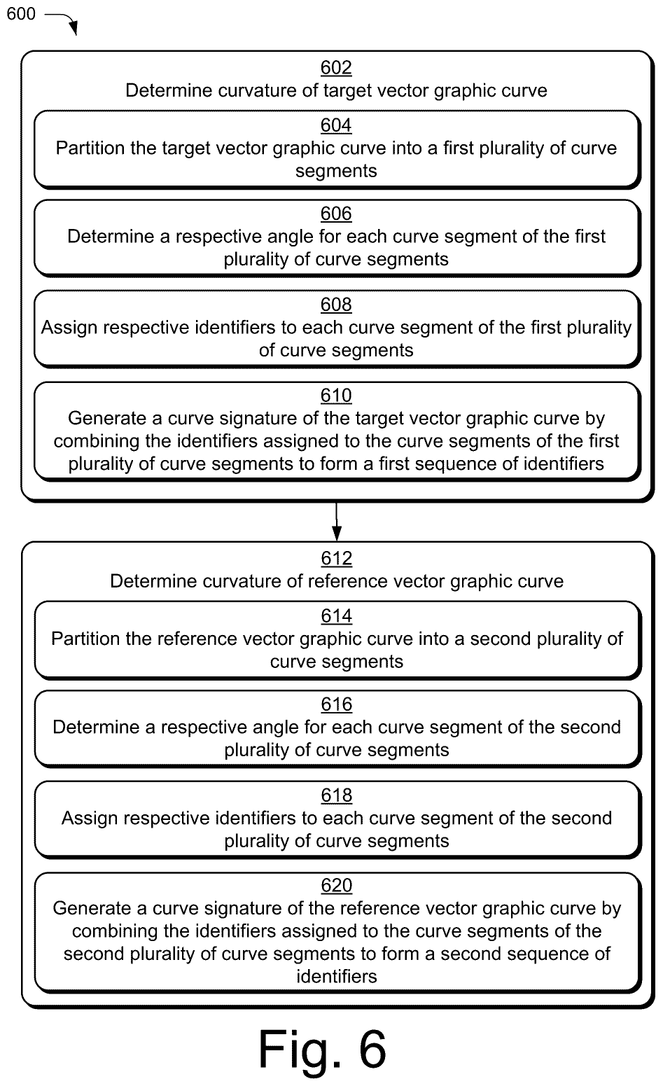

The following discussion describes curvature comparison techniques that are implementable utilizing the described systems and devices. Aspects of the procedure are implemented in hardware, firmware, software, or a combination thereof. The procedure is shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIGS. 5A-5B show a flow diagram depicting an algorithm as a step-by-step procedure 500 in an example implementation of operations performable for accomplishing a result of curvature comparison in a digital image. In some instances, the procedure 500 includes a procedure 600 for determining curvatures as shown by the diagram of FIG. 6, with procedure 600 performed as a portion of procedure 500. In portions of the following discussion, reference will be made to FIGS. 2-4 in parallel with the procedure 500 of FIGS. 5A-5B and the procedure 600 of FIG. 6.

FIG. 2 depicts an example implementation 200 showing operation of the curvature system 132 of FIG. 1 in greater detail. To begin in this example, a digital image 112 is received as an input by the curvature system 132. The digital image 112 includes vector content 114 that is used as a basis to generate an edited target vector curve 224. The vector content 114 is configurable to include vector paths forming vector curves, e.g., Bezier curves. The digital image editing system including the curvature system 132 is operable to edit vector content within the digital image, such as the vector paths forming vector curves. The digital image editing system is further operable in some configurations to edit non-vector content within the digital image, such as raster content. The curvature system 132 is operable to employ curvature comparison and curvature editing of the vector curves included by the digital image.

The curvature system 132 determines conditions of the digital image editing system, to which, the digital image 112 is provided (block 502). In some instances, the curvature system 132 determines operating conditions such as a number of vector curves within the digital image, a selected editing tool of the digital image editing system, a vector curve of the digital image selected for editing, and so forth.

A curve input module 202 is employed to acquire a target vector curve 204 based on the determined conditions (block 504). For instance, the curve input module is operable to acquire the target vector curve from a vector curve selected for editing, e.g., set the selected curve as the target vector curve.

As shown in more detail by FIG. 3, a signature generation module 206 processes the target vector curve to determine a curvature of the target vector curve 204 (blocks 506 and 602). In doing so, the signature generation module 206 generates a curve signature associated with the target vector curve 204 that describes the curvature of the target vector curve 204 using a sequence of identifiers, as discussed further below in relation to FIG. 3.

The signature generation module 206 addresses several technical challenges associated with characterizing the curvature of a vector curve. For instance, vector curves are configurable with a wide variety of different curvatures. Although some conventional techniques for representing the curvatures of vector curves use Bernstein polynomials with a set of four x-y coordinates, the vector curves often have various complexities such as inflexion points, cusps, loops, and so forth that complicate the curvature representation using such techniques. Further, when multiple vector curves are connected, the connection points are configurable as C0, C1, or G1 continuous, or the connection points form sharp corners instead of smooth continuous transitions. Such characteristics result in shapes that have several changes in direction or curvature.

In order to account for such potential complications, the signature generation module 206 partitions (e.g., discretizes or bucketizes) the target vector curve 204 into a set of uniformly sampled points along the length of the target vector curve 204 (block 604). The set of sampled points thus defines a set of curve segments of the target vector curve 204. To determine the curvature of each curve segment, the signature generation module 206 computes a tangent angle or normal angle to the target vector curve 204 subtended at each of the curve segments defined by the sampled points (block 606).

The computed angles are used as a basis for generating the curve signature describing the entire curvature of the target vector curve 204. In particular, each of the computed angles is assigned an identifier based on the amount, e.g., degree, of the angle (block 608). In some instances, angles between 0-5 degrees are assigned the identifier “A,” angles between 6-10 degrees are assigned the identifier “B,” angles between 11-15 degrees are assigned the identifier “C,” and so forth. The identifiers are then concatenated together to form the curve signature of the target vector curve 204 (block 610), with the curve signature indicating the piecewise curvature of the entire target vector curve.

For instances in which the target vector curve 204 is a vector path including multiple vector curves, the signature generation module 206 generates a respective curve signature for each vector curve and joins the signatures, e.g., concatenates the signatures, to form the curve signature of the entire vector path. As the curve signature of the entire vector path includes the curve signatures of the vector curves of the vector path, various string operations such as substring matching and signature reversal are performable during curve comparison (as described below) to compare portions or sections of the vector path, such as the individual vector curves of the vector path, to other vector curves.

The signature generation module 206 normalizes the scale of the target vector curve 204 during the processing of the target vector curve 204 to provide the curve signature with scale-invariant encoding. The normalizing of the scale, or normalization, includes calculating a normalized size of the target vector curve 204 based on a pre-determined size while maintaining an x/y aspect ratio of the target vector curve 204. The size of the target vector curve 204 refers to the dimensions of the target vector curve 204 in the x-direction and the y-direction, e.g., the horizontal direction and the vertical direction, respectively. The dimensions in the x-direction and the y-direction are definable in units such as pixels, points, and so forth.

In an example, the non-normalized scale of the target vector curve 204 is 1.0×, and the non-normalized size of the target vector curve 204 is 240 pixels in the x-direction and 380 pixels in the y-direction. In this example, the pre-determined size is 100 pixels in the x-direction. To normalize the size of the target vector curve 204 based on the pre-determined size, the signature generation module 206 calculates the normalized scale of the target vector curve 204, which in this example is 0.417. At the normalized scale, the size of the target vector curve 204 in the x-direction is 100 pixels and the size in the y-direction is 158 pixels. The sizes and scales described above are for example only and other sizes and scales are possible. Further, in some instances the normalization of the target vector curve 204 is performed using the pre-determined size in the y-direction rather than the x-direction. In the example described above, normalizing the target vector curve 204 using a pre-determined size of 100 pixels in the y-direction instead of the x-direction results in a normalized size of 63 pixels in the x-direction and 100 pixels in the y-direction, and a normalized scale of 0.263.

The normalization of the target vector curve 204 is performed by the signature generation module 206 without altering the size of the target vector curve 204 within the digital image. The normalization is performed via a calculation, with inputs of the calculation being the non-normalized size, the non-normalized scale, and the pre-determined size, and with outputs of the calculation being the normalized size and the normalized scale. Similarly, the partitioning of the target vector curve 204 is performed via a calculation without altering the target vector curve 204 within the digital image.

The partitioning includes determining the set of uniformly sampled points based on the normalized target vector curve. For instance, the sampled points are determined such that the target vector curve 204 is partitioned into ten curve segments. By normalizing the target vector curve 204 prior to sampling the points, the size of each curve segment is controlled. In an example in which the target vector curve 204 is normalized based on a pre-determined size of 100 pixels in the x-direction and the target vector curve 204 is partitioned into 10 curve segments, the length of each curve segment in the x-direction is controlled to be 10 pixels. Other examples are possible.

Normalizing the target vector curve 204 to control the size of the curve segments determined via the partitioning supports size-invariant encoding of the curve signature of the target vector curve 204. In particular, without performing normalization, the curve segments determined via partitioning have a size that depends on the present scale of the target vector curve 204 within the digital image. For instance, partitioning the target vector curve 204 into ten curve segments while the target vector curve 204 is at a larger, first scale results in a larger size of curve segments compared to partitioning the target vector curve 204 into ten curve segments while the target vector curve 204 is at a smaller, second scale. Further, the angles determined for the curve sections depend on the scale of target vector curve 204 within the digital image, e.g., with the angles being different when the target vector curve 204 is at different scales due to the different curve segment sizes. However, by normalizing the target vector curve 204, comparison of the curvature of the target vector curve 204 to curvatures of other curves within the digital image is accomplished without undesired irregularities resulting from the curves being at different scales.

The signature generation module 206 generates the curve signature 208 of the target vector curve 204 via the processing of the target vector curve 204 as described above, e.g., normalizing the target vector curve 204, partitioning the target vector curve 204, determining the curve segment angles, and assigning identifiers to the curve segments based on the angles. The curve signature 208 is also referred to herein as the target signature 208. The concatenated identifiers form a first identifier sequence 300, as shown by FIG. 3, which is referred to herein as the single encoding sequence. In some instances, the signature generation module 206 further generates various other identifier sequences and subsequences based on the single encoding sequence, such as a second identifier sequence 302 referred to herein as the double encoding sequence, a non-repeating subsequence 304, and a delta subsequence 306, as described below.

The double encoding sequence is a repeating sequence formed based on the first encoding sequence. In particular, the double encoding sequence includes the first encoding sequence concatenated with itself, such that the first encoding sequence repeats within the double encoding sequence. When comparing the curve signature of the target vector curve 204 to other curve signatures as described further below, the double encoding sequence increases a likelihood of detecting portions of the curve signatures that match each other, particularly during conditions in which curve signatures of closed vector paths are compared. Closed vector paths refer to vector paths that do not include an open end, e.g., each vertex of the vector path is joined to two other adjacent vertices of the vector path. Closed vector paths present challenges with curvature comparison. Often, a beginning/end location of a closed vector path is not readily discernable, and matching a beginning of the closed vector path to a beginning of the target vector curve 204 may be difficult. However, by configuring the curve signature of the target vector curve 204 to include the double encoding sequence, matching portions (or an entirety) of the curvature of the target vector curve 204 to curvatures of closed vector paths is supported.

The non-repeating subsequence 304, as shown by FIG. 3, is based on the single encoding sequence 300 and includes a non-repeating series of identifiers. In particular, the non-repeating subsequence 304 includes the content of the single encoding sequence 300 but is modified such that two or more adjacent identifiers having a same type are reduced to a single identifier. For instance, in the example shown by FIG. 3, the single encoding sequence 300 is GFFFEEEDDDCBBAAA. The sequence includes one instance of the identifier ‘G,’ three adjacent instances of the identifier ‘F,’ three adjacent instances of the identifier ‘E,’ three adjacent instances of the identifier ‘D,’ one instance of the identifier ‘C,’ two adjacent instances of the identifier ‘B,’ and three adjacent instances of the identifier ‘A.’ To form the non-repeating subsequence 304, the signature generation module 206 reduces the three adjacent instances of the identifier ‘F’ to a single instance, reduces the three adjacent instances of the identifier ‘E’ to a single instance, reduces the three adjacent instances of the identifier ‘D’ to a single instance, reduces the two adjacent instances of the identifier ‘B’ to a single instance, and reduces the three adjacent instances of the identifier ‘A’ to a single instance.

By configuring the target signature 208 to include the non-repeating subsequence 304, matching of the curvature of the target vector curve 204 to the curvatures of other curves is supported even during conditions in which a number of vertices and/or sections of the target vector curve 204 is different from a number of vertices and/or sections of the other curves. For instance, different vector paths with the same curvature are often formed from different numbers of vertices and/or different amounts of connected curves.

As an example, a vector path forming an ellipse shape has a curvature definable by four cubic Bezier curves. However, another vector path forming the ellipse shape with the same curvature includes a different number of Bezier curves, such as five curves, six curves, or another amount of curves. Because the signature generation module 206 normalizes curves while the curves are processed to generate curve signatures, vector paths that include larger numbers of curves have curve signatures with longer single encoding sequences relative to vector paths that include smaller numbers of curves. For example, a single encoding sequence of a curve signature of the vector path forming the ellipse shape using four cubic Bezier curves is shorter than a single encoding sequence of a curve signature of the vector path forming the ellipse shape with more than four curves.

By configuring the target signature 208 to include the non-repeating subsequence 304, an ease of matching the target signature 208 to curve signatures of other vector paths is increased along with a corresponding increase in processing efficiency of a computing device. In particular, as a number of vertices and/or curves of the target vector curve 204 increases, the length of the single encoding sequence 300 of the target signature 208 of the target vector curve 204 also increases. However, because the non-repeating subsequence 304 reduces duplicate instances of identifiers arranged adjacent to each other within the single encoding sequence 300, as the number of vertices and/or curves of the target vector curve 204 increase (while maintaining the same overall curvature of the target vector curve 204), the length of the non-repeating subsequence 304 does not increase. Therefore, the non-repeating subsequence 304 increases an ease of curve signature comparison, in particular between vector paths having large numbers of vertices and/or curves.

The delta subsequence 306 of the target signature 208 as shown by FIG. 3 includes identifiers indicating an amount of difference between adjacent identifiers of the single encoding sequence 300, double encoding sequence 302, and/or non-repeating subsequence 304. For instance, in some examples the delta subsequence 306 is based on the single encoding sequence 300 and includes a series of identifiers indicating the amount of difference between adjacent identifiers of the single encoding sequence 300. In other examples, the delta subsequence 306 is based on the double encoding sequence 302 and includes identifiers indicating the amount of difference between adjacent identifiers of the double encoding sequence 302. In yet other examples, the delta subsequence 306 is based on the non-repeating subsequence 304 and includes identifiers indicating the amount of difference between adjacent identifiers of the non-repeating subsequence 304. In some instances, the target signature 208 includes each of the above-described versions of the delta subsequence 306 (e.g., the version based on the single encoding sequence, the version based on the double encoding sequence, and the version based on the non-repeating subsequence).

The delta subsequence 306 indicates the change (e.g., difference) between angles determined for adjacent curve segments resulting from the partitioning of the target vector curve 204. Because the delta subsequence 306 indicates the amount of change between adjacent angles, the delta subsequence 306 describes the curvature of the target vector curve 204 independent of an amount of rotation of the target vector curve 204. For example, the delta subsequence 306 of the curve signature of the target vector curve 204 is the same during conditions in which the target vector curve 204 is in a first orientation and during conditions in which the target vector curve 204 is in a different, second orientation. The delta subsequence 306 thus supports a rotationally-invariant measure of the curvature of the target vector curve 204.

As an example, consider a vector path portion with a curve signature defined by the sequence of identifiers “DCFB.” The delta subsequence is determined by determining a first identifier indicating the difference between the identifiers “D” and “C,” determining a second identifier indicating the difference between the identifiers “C” and “F,” and determining a third identifier indicating the difference between the identifiers “F” and “B.” The resulting delta subsequence is a concatenation of the first, second, and third identifiers, and in this example, the delta subsequence is “aCd,” where uppercase and lowercase identifiers indicate change in different directions, e.g., positive or negative change.

In some instances, the target signature 208 further includes a reversed version of one or more of the sequences or subsequences described above. For example, the target signature 208 is configurable to include a reversed sequence based on the single encoding sequence 300, where the reversed sequence includes the series of identifiers of the single encoding sequence 300 concatenated in an order that is reversed relative to the order of the identifiers of the single encoding sequence 300. Using the example described further above, the single encoding sequence 300 in the example shown is GFFFEEEDDDCBBAAA. The reversed sequence of the single encoding sequence 300 is AAABBCDDDEEEFFFG. Including the reversed sequence supports comparing of the curvature of the target vector curve 204 to the curvature of other vector paths, even during conditions in which the target vector curve 204 or the other vector paths are in a reversed orientation relative to each other or conditions in which a beginning location and end location of the target vector curve 204 are mirrored relative to one or more other paths.

By including the sequences and subsequences described above within the curve signature, the curvature of the target vector curve 204 has increased comparability to curvatures of other vector paths regardless of scale or orientation of the target vector curve 204. As such, the curve signature indicates the curvature of the target vector curve 204 with both of rotational invariance and scale invariance.

In addition to generating the curve signature of the target vector curve 204, the signature generation module 206 is operable to generate curve signatures for other curves within the digital image. Such curves are referred to herein as candidate vector curves 210, as shown in FIG. 2. The curvature system 132 stores each of the generated curve signatures, e.g., to non-transitory memory. The curvature system 132 further retrieves the stored curve signatures while performing curvature comparison operations as described further below. In some instances, the candidate vector curves 210 include each vector curve within the digital image that is not the target vector curve 204. The signature generation module 206 processes the candidate vector curves 210 to form a set of candidate signatures 212. The processing of the candidate vector curves 210 is similar to the processing of the target vector curve 204 described above.

The target signature 208 and the candidate signatures 212 are provided to a reference selection module 214. The reference selection module 214 determines one or more reference vector curves from the plurality of candidate vector curves 210 based on various parameters. Such parameters include, in some instances, distance from the target vector curve 204 within the digital image, and/or curve length. The one or more reference vector curves are determined by the reference selection module 214, e.g., selected from among the candidate vector curves 210, for comparison with the target vector curve 204. The reference selection module 214 further identifies the curve signatures associated with the one or more reference vector curves, such as reference signature 216, and provides the curve signatures and the target signature 208 to a curvature comparison module 218 for comparison, as described below. In some instances the reference signature 216 is included within the set of candidate signatures 212 and is generated using a process similar to that used to generate the target signature 208 (blocks 612, 614, 616, 618, and 620).

The curvature comparison module 218 receives the target signature 208 and the reference signature 216 and processes each of the signatures to determine portions of the target signature 208 that correspond to (e.g., match) portions of the reference signature 216 (block 508). As described above, the target signature 208 includes various strings, or sequences, of concatenated identifiers that indicate the curvature of the target vector curve 204. Similarly, the reference signature 216 includes strings of concatenated identifiers that indicate the curvature of the corresponding reference vector curve determined from the set of candidate vector curves 210. The curvature comparison module 218, for instance, compares the identifier sequences included by the target signature 208 to the identifier sequences included by the reference signature 216 to determine whether portions of the target signature 208 match, or are equal to, portions of the reference signature 216.

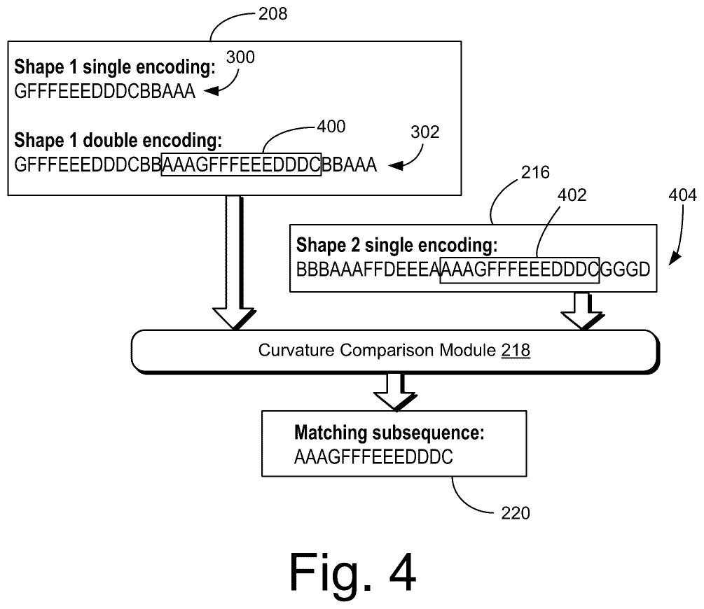

In some examples, determining matching portions of the target signature 208 and the reference signature 216 includes determining an exact series of identifiers included by the target signature 208 that is also included by the reference signature 216. As shown by FIG. 4, the target signature 208 includes the single encoding sequence 300 and the double encoding sequence 302. The target signature 208 is configurable to include additional sequences and subsequences as described above, although FIG. 4 omits the additional sequences and subsequences for clarity of illustration. In the view shown by FIG. 4, the target vector curve 204 is referred to as “Shape 1” and the reference vector curve is referred to as “Shape 2.”

In the example shown, the double encoding sequence 302 of the target signature 208 includes the series of identifiers “GFFFEEEDDDCBBAAAGFFFEEEDDDCBBAAA.” A single encoding sequence 404 of the reference signature 216 includes the series of identifiers “BBBAAAFFDEEEAAAAGFFFEEEDDDCGGGD.” The curvature comparison module 218 processes each of the target signature 208 and the reference signature 216, which includes comparing the double encoding sequence 302 of the target signature 208 with the single encoding sequence 404 of the reference signature 216. The curvature comparison module 218 determines that a portion 400 of the target signature 208 is within a tolerance of a portion 402 of the reference signature 216 (block 510), and as a result, the curvature comparison module 218 outputs a matched curvature 220. In the example shown, the portion 400 and the portion 402 match each other, e.g., include the same series of identifiers “AAAGFFFEEEDDDC,” and the matched series of identifiers is included within the matched curvature 220.

It should be noted that the curvature system 132 is operable to perform the above-described operations continuously throughout editing of the curvature of the target vector curve 204. For example, during active editing of the curvature of the target vector curve 204, such as editing that includes transitioning one or more vertices of the target vector curve 204 from one position to another, the curvature system 132 monitors the curvature of the target vector curve 204 and updates the target signature 208 accordingly responsive to changes to the curvature.

In some instances, the matched curvature 220 output by the curvature comparison module 218 is a curvature of the reference vector curve that is within a tolerance of the curvature of the target vector curve 204 (block 514). In some instances, the tolerance is expressed as a percentage difference. For example, the tolerance of the curvature of the reference vector curves is configurable as +/−5%, such that during conditions in which the curvature of the target vector curve is less than 5% different than the curvature of the reference vector curves, the curvature comparison module outputs the matched curvature 220 based on the reference signature 216. In other examples, the tolerance is a different percentage difference (e.g., 10%, 15%, or another amount) forming a range of curvatures centered around the curvature of the reference vector curve.

In yet other examples, the tolerance is based on a number of identifiers of the target signature 208 that are different from identifiers of the reference signature 216. For instance, the tolerance is definable as two identifiers difference, three identifiers difference, or another amount of difference between sequential identifiers included by the target signature 208 and sequential identifiers included by the reference signature 216. In yet other examples, the tolerance is based on the amount of difference between the identifiers. For instance, some identifiers indicate greater amounts of curvature and other identifiers indicate smaller amounts of curvature.

As one example, a difference between curvature indicated by the identifier “G” and curvature indicated by the identifier “A’ is larger than a difference between curvature indicated by the identifier “G” and curvature indicated by the identifier “F.” The tolerance is configurable such that smaller differences in curvature, such as the difference in curvature represented by the identifier “G” relative to the identifier “F,” are considered by the curvature comparison module 218 to be within the tolerance. Similarly, the tolerance is configurable such that larger differences in curvature, such as the difference in curvature represented by the identifier “G” relative to the identifier “A,” are not considered by the curvature comparison module 218 to be within the tolerance. In some instances, while the curvatures are not within tolerance of each other, the digital image editing system conditions are maintained (block 512), e.g., the curvature system maintains the curvatures of the target vector curve and reference vector curve without replacement.

The matched curvature 220 generated by the curvature comparison module 218 is provided to a curvature editing module 222. The curvature editing module 222 is operable to replace the curvature of the target vector curve 204 with the curvature defined by the matched curvature 220 (block 524), which is definable as a surrogate curvature and/or edited curvature. In particular, the curvature editing module 222 adjusts, e.g., edits, the curvature of the target vector curve 204 to the matched curvature 220, where the matched curvature 220 is based on the curvature described by the reference signature 216 as discussed above. The replacement of the curvature of the target vector curve 204 with the curvature defined by the matched curvature 220 is formed in some instances responsive to user input applied via a user interface device, such as a mouse or keyboard, to a user confirmation prompt displayed at the display device by the curvature system (block 520). In some instances, without the user input to the user confirmation prompt, the digital image editing conditions are maintained (block 522), e.g., the curvature of the target vector curve 204 is not replaced with the curvature defined by the matched curvature 220. In some instances, the curvature editing module 222 is configurable to display the edited curvature, or portion of the curvature of the target vector curve 204 to be replaced, as a target curve guide (block 516). Various examples of target curve guides are described further below. Further, in some instances, the curvature editing module 222 is configurable to display the matched portion of the curvature of the reference vector curve as a reference curve guide (block 518). Various examples of reference curve guides are also described further below. The curvature of the target vector curve 204 is thus adjusted by the curvature system 132 based on the curvature of the reference vector curve, with the target vector curve 204 replaced by the curvature editing module 222 with an edited target vector curve 224.

Further examples of operations performable via the curvature system 132 are described below.

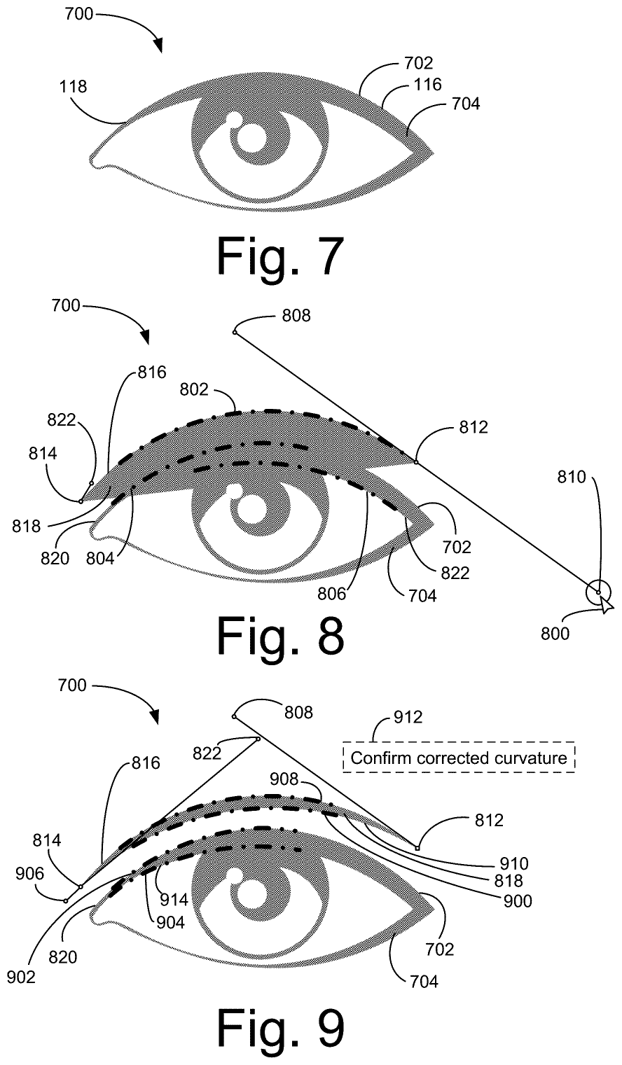

Referring collectively to FIGS. 7-9, vector graphic content 700 is shown. The vector graphic content 700 is included within a digital image, such as the digital image 112 shown by FIG. 1 and described above. Modification of the digital image and the vector graphic content 700 is supported by the digital image editing system 130 including curvature system 132 described above with reference to FIG. 1. The vector graphic content 700 includes a plurality of vector paths forming vector curves which are independently adjustable via the aforementioned digital image editing system. Example adjustments include adjustment to a position of one or more of the vector curves, adjustment to an orientation of one or more of the vector curves (e.g., by rotating the vector curves), adjustment to a scale of one or more vector curves, and so on. Adjusting the orientation includes rotating the one or more vector curves, and adjusting the scale includes resizing the one or more vector curves.

FIGS. 7-9 show vector graphic content 700 throughout various stages of manipulation of the curves. In particular, FIG. 7 shows the vector graphic content 700 in a first stage in which the vector curves included by the vector graphic content 700 are not selected (e.g., targeted), FIG. 8 shows vector graphic content 700 in a second stage in which a vector curve 816 is generated and selected and includes a fill 818, and FIG. 9 shows vector graphic content 700 in a third stage in which the vector curve 816 is connected to another vector curve 910. The vector graphic content 700 is displayed by a display device, such as display device 106 shown by FIG. 1 and described above, via digital image editing system 130 described above with reference to FIG. 1. The digital image editing system includes the curvature system 132 described above.

FIG. 7 shows the vector graphic content 700 in isolation as it would appear on the display device. The vector graphic content 700 includes a vector object 702 having a fill 704. In one example, the fill 704 is a solid color, and in other examples, the fill 704 is a pattern. The fill 704 applied to the object 702 modifies the appearance of the object 702 as displayed by the digital image editing system but does not modify the shape of the vector paths to which the fill 704 is applied. The vector graphic content 700 is comprised of a plurality of vector curves, with each of the vector curves defined by one or more Bezier curves, e.g., cubic or quadratic Bezier vector curves. Curvatures of the vector curves are definable by the Bezier curves. The vector graphic content 700 includes the same vertices, vector curves, and control handles as the vector content 114 shown by FIG. 1 and described above. For example, the vector graphic content 700 includes vector curve 116 and vector curve 118 described above with reference to FIG. 1. However, in the view shown by FIG. 7, the fill 704 has been applied to the vector curves forming a closed shape. Further, in the view shown by FIG. 7, the vector curves are shown without strokes, e.g., without stroke lines following along the vector curves with a thickness of the stroke lines selected via user input. User input includes input applied via a user interface device such as a mouse, trackpad, keyboard, and the like, in some examples.

In the view shown by FIG. 8, the vector graphic content 700 is shown in the second stage. The view shown by FIG. 8 represents a moment during a real-time adjustment (e.g., modification) of the vector graphic content 700. In particular, FIG. 8 illustrates the generation of vector curve 816 within the vector graphic content 700. The generation of vector curve 816 includes generation of vertex 814 having control handle 822. In one example, the vertex 814 is the beginning vertex of the vector curve 816. The beginning vertex refers to the first vertex generated to form the vector curve. The generation of vector curve 816 additionally includes generation of vertex 812 having a first control handle 808 and a second control handle 810.

In the stage shown by FIG. 8, the vertex 812 is the end vertex of the vector curve 816. The positions of the vertices and control handles of the vector graphic content 700 are controllable (e.g., adjustable) by way of user input to control cursor 800 displayed by the display device. The cursor 800 is controllable via a user interface device such as a mouse, keyboard, trackpad, etc. (e.g., similar to the I/O interfaces shown by FIG. 17 and described further below) to interact with the vertices and control handles. As one example, in order to adjust the curvature of the vector curve 816, the first control handle 808 is selected via user input using the cursor 800 and the first control handle 808 is moved to a different position with the cursor 800 responsive to the user input.

FIG. 8 additionally shows a target curve guide 802, a first reference curve guide 804, and a second reference curve guide 806. The target curve guide 802, the first reference curve guide 804, and the second reference curve guide 806 are generated according to the procedures described herein to assist with matching the curvature of the selected (e.g., targeted) vector curve 816 to the curvature of a first reference vector curve 820 and a second reference vector curve 822. Because the vector curve 816 is selected in the stage shown by FIG. 8, the vector curve 816 is referred to as the target vector curve. As a result of the selection of the vector curve 816, the digital image editing system displays the control handles and vertices of the vector curve 816. However, during other conditions in which the vector curve 816 is not selected, the vertices and control handles are configurable to be hidden. In the example shown, the first reference vector curve 820 and the second reference vector curve 822 each have similar curvature.

The curvature system of the digital image editing system compares the curvature of the target vector curve 816 to the curvature of each of the first reference vector curve 820 and the second reference vector curve 822. The curvature system further compares the curvature of the target vector curve 816 to each other vector curve within the vector graphic content 700.

In the example shown by FIG. 8, the curvature of the target vector curve 816 matches the curvature of the first reference vector curve 820 and the second reference vector curve 822 and does not match the curvature of other vector curves within the vector graphic content 700. As a result, the first reference curve guide 804 and the second reference curve guide 806 are shown, but additional reference curve guides are not shown due to the difference between the curvature of the target vector curve 816 and the other vector curves within the vector graphic content 700. In particular, the curvature of the target vector curve 816 is within a tolerance of the curvature of the first reference vector curve 820 and the second reference vector curve 822, resulting in the display of the reference curve guides. However, the curvature of the target vector curve 816 is not within a tolerance of the curvature of other vector curves within the vector graphic content 700, and as a result, additional reference curve guides are not displayed.

As described above, the view shown by FIG. 8 represents a moment during the modification of the vector graphic content 700, and at the moment depicted, the curvature of the target vector curve 816 is within the tolerance of the curvature of the first reference vector curve 820 and the second reference vector curve 822. However, at other moments, such as other moments throughout adjustment of the curvature of the target vector curve 816, the curvature of the target vector curve 816 is not within the tolerance of the first reference vector curve 820 or the second reference vector curve 822.

While the curvature of the target vector curve 816 is not within the tolerance of the first reference vector curve 820 or the second reference vector curve 822, the first reference curve guide 804 and the second reference curve guide 806 are not displayed by the display device. During conditions in which the curvature of the target vector curve 816 is within the tolerance of the curvature of other vector curves within the vector graphic content 700, reference curve guides are displayed at those vector curves to indicate the similarity between the curvature of the target vector curve 816 and the curvature of the other vector curves.

In the views shown, the curve guides, including the target curve guide 802, the first reference curve guide 804, and the second reference curve guide 806, are shown in dash-dot broken lines. However, in some examples, the curve guides are shown with a different appearance, such as a contrasting color, contrasting thickness, etc.

The view shown by FIG. 9 shows the vector graphic content 700 in the third stage of modification (e.g., adjustment). In the third stage, the vector curve 816 has been deselected (e.g., untargeted), while vector curve 910 has been generated and the curvature of the vector curve 910 is being adjusted via user input. In the view shown, the vector curve 910 is selected and is referred to as the target vector curve. As the vector curve 910 is selected, control handle 906 of vertex 814 is displayed. Because the vector curve 910 is targeted, the curvature of the vector curve 910 is compared to the curvature of each other vector curve within the vector graphic content 700.

The curvature system determines that the curvature of the vector curve 910 is within the tolerance of the curvature of vector curve 820, vector curve 914, and vector curve 816. As a result, the curvature system displays reference curve guide 904 at vector curve 914, reference curve guide 902 at vector curve 820, reference curve guide 908 at vector curve 816, and target curve guide 900 at vector curve 910 to visually indicate the similarly between the curvature of the vector curve 910 and the curvature of the aforementioned vector curves.

In some examples, the curvature system displays a user confirmation prompt 912 during conditions in which the curvature of the selected (e.g., targeted) vector curve is within the tolerance of the curvature of one or more other vector curves within the vector graphic content 700. User input applied at the user confirmation prompt accepts the edited curvature of the selected vector curve indicated by the target curve guide 900. In one example, the user input includes input of a confirmation action to the user confirmation prompt, such as selection of the user confirmation prompt with the cursor 800. Responsive to the user input at the user confirmation prompt, the curvature system replaces the curvature of the target vector curve with the edited curvature.

In some instances, the tolerance is expressed as a percentage difference, similar to the examples described above. In some instances, the tolerance is based on a number of identifiers of the curve signature of the target vector curve that are different from identifiers of the curve signatures of the reference vector curves, similar to the examples described above.

Reference vector curves, as described herein, refer to unselected (e.g., untargeted) vector curves having curvatures to which the curvature of the selected (e.g., targeted) vector curve is compared.

By generating the curve guides and the edited curvature of the target vector curve, the curvature of the target vector curve is more easily adjustable to match the curvature of other vector curves within the digital image.

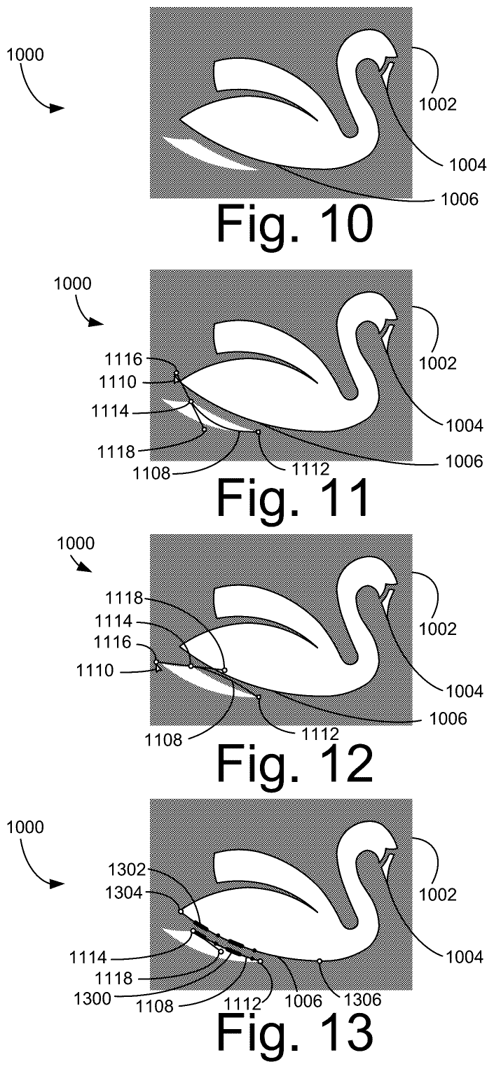

Referring collectively to FIGS. 10-13, another example of vector graphic content 1000 included by a digital image is shown. The vector graphic content 1000 includes a plurality of vector curves, and FIGS. 10-13 show the vector graphic content 1000 in various stages of adjustment. In particular, FIG. 10 shows the vector graphic content 1000 in a first stage in which the vector curves included by the vector graphic content 1000 are not selected (e.g., targeted), FIG. 11 shows vector graphic content 1000 in a second stage in which a vector curve 1108 is generated, selected (e.g., targeted), and includes a first intermediate curvature, FIG. 12 shows vector graphic content 1000 in a third stage in which the vector curve 1108 has a second intermediate curvature, and FIG. 13 shows vector graphic content 1000 in a fourth stage in which the vector curve 1108 has an edited curvature. The vector graphic content 1000 is displayed by a display device, such as display device 106 shown by FIG. 1 and described above, via a digital image editing system, such as the digital image editing system 130 described above with reference to FIG. 1. The digital image editing system includes the curvature system 132 described above.

In the first stage shown by FIG. 10, the vector curves included by the vector graphic content 1000 are not selected, e.g., not targeted. Vector graphic content 1000 includes background image 1002 (e.g., a raster image), vector curve 1004, and vector curve 1006. Vector curve 1004 and vector curve 1006 each have a stroke applied such that the display device displays the vector curve 1004 and vector curve 1006 with a thickness defined by the stroke weight. The strokes applied to the vector curves modify the appearance of the vector curves as displayed by the digital image editing system but do not modify the shapes of the vector curves to which the strokes are applied. Strokes applied to the vector curves are configurable to have different weights, colors, tapers, etc. without altering the shapes, e.g., curvatures, of the vector curves to which the strokes are applied. The vector curve 1004 and the vector curve 1006 are arranged higher than the background image 1002 in an order of an object stack supported by the digital image editing system, such that the vector curve 1004 and the vector curve 1006 have the appearance of being on top of the background image 1002.

In the second stage shown by FIG. 11, vector curve 1108 has been generated and includes vertex 1112, vertex 1114, control handle 1116, and control handle 1118. A cursor 1110 controllable via user input is additionally shown, similar to cursor 800 described above with reference to FIG. 8. In the second stage, a curvature of the vector curve 1108 is not within a tolerance of curvatures of other vector curves included by the vector graphic content 1000, where the tolerance is similar to the tolerance in the examples described above. Because the curvature of the vector curve 1108 is not sufficiently similar to the curvature of the other vector curves, the curvature system does not display curve guides at the vector curve 1108 or the other vector curves.

In the third stage shown by FIG. 12, the vector curve 1108 has been adjusted to have a curvature different than the curvature shown by FIG. 11. However, as the curvature shown by FIG. 12 is not within the tolerance of the curvatures of the other vector curves included by vector graphic content 1000, the curvature system does not display curve guides at the vector curves.

In the fourth stage shown by FIG. 13, the curvature of the vector curve 1108 is within the tolerance of the curvature of vector curve 1006. The vector curve 1108 is the target vector curve and the vector curve 1006 is the reference vector curve. As a result, the curvature system displays target curve guide 1300 at the vector curve 1108. Further, the curvature system displays reference curve guide 1302 at the vector curve 1006. Vertex 1304 and vertex 1306 of the reference vector curve are shown to indicate that the reference curve guide 1302 spans a portion of the reference vector curve and not an entirety of the reference vector curve. In particular, in the example shown, the curvature of the target vector curve is within the tolerance of the curvature of the portion of the reference vector curve indicated by the reference curve guide 1302.

In some examples, the curvature system further displays a user confirmation prompt to prompt for user input to confirm adjustment of the curvature of the vector curve 1108 to the edited curvature indicated by the target curve guide 1300. The user confirmation prompt is similar to the user confirmation prompt shown by FIG. 9 and described above, in some examples.

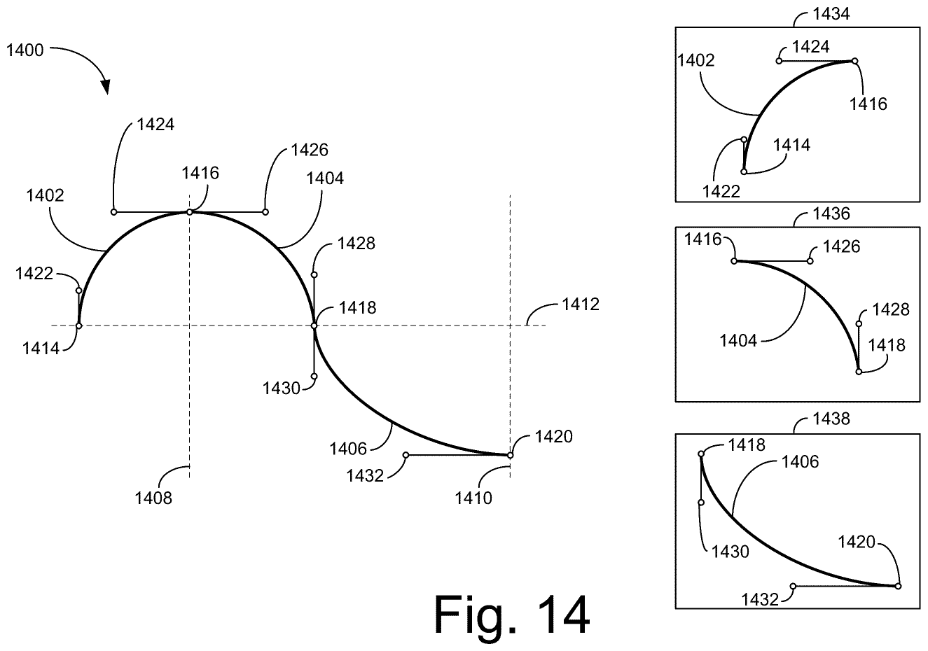

Referring to FIG. 14, an example vector curve 1400 is shown. The vector curve 1400 is displayed via a digital image editing system, such as the digital image editing system 130 described above with reference to FIG. 1, through a display device, such as the display device 106 described above with reference to FIG. 1. The digital image editing system includes the curvature system 132 described above with reference to FIG. 1. In some examples, the vector curve 1400 is a target vector curve during conditions in which the vector curve 1400 is selected, e.g., targeted. In other examples, the vector curve 1400 is a reference vector curve during conditions in which the vector curve 1400 is unselected, e.g., untargeted. As one example, vector curve 1400 is unselected while another vector curve of the vector graphic content is selected, such that vector curve 1400 is a reference vector curve in relation to the selected curve. Vertical axis 1408, vertical axis 1410, and horizontal axis 1412 are shown intersecting the vertices of the vector curve 1400.

The vector curve 1400 includes a plurality of Bezier curves defining a curvature of the vector curve 1400. In particular, vector curve 1400 includes a first Bezier curve 1402 defined by vertex 1414, vertex 1416, control handle 1422, and control handle 1424, a second Bezier curve 1404 defined by vertex 1416, vertex 1418, control handle 1426, and control handle 1428, and a third Bezier curve 1406 defined by vertex 1418, vertex 1420, control handle 1430, and control handle 1432. The first Bezier curve 1402 is joined to the second Bezier curve 1404 via vertex 1416, and the third Bezier curve 1406 is joined to the second Bezier curve 1404 via vertex 1418. The first Bezier curve 1402 is shown in isolation by inset 1434, the second Bezier curve 1404 is shown in isolation by inset 1436, and the third Bezier curve 1406 is shown in isolation by inset 1438.

During conditions in which a curve signature of the vector curve 1400 is generated by the curvature system (e.g., conditions in which the vector curve 1400 is a target vector curve or reference vector curve), the curvature system generates the curve signature based on the curvature of each of the Bezier curves. As one example, the curve signature includes a sequence of identifiers indicating the curvature of each of the Bezier curves, and the curve signature is generated based on normalized parameters (e.g., a normalized size) of the vector curve 1400.

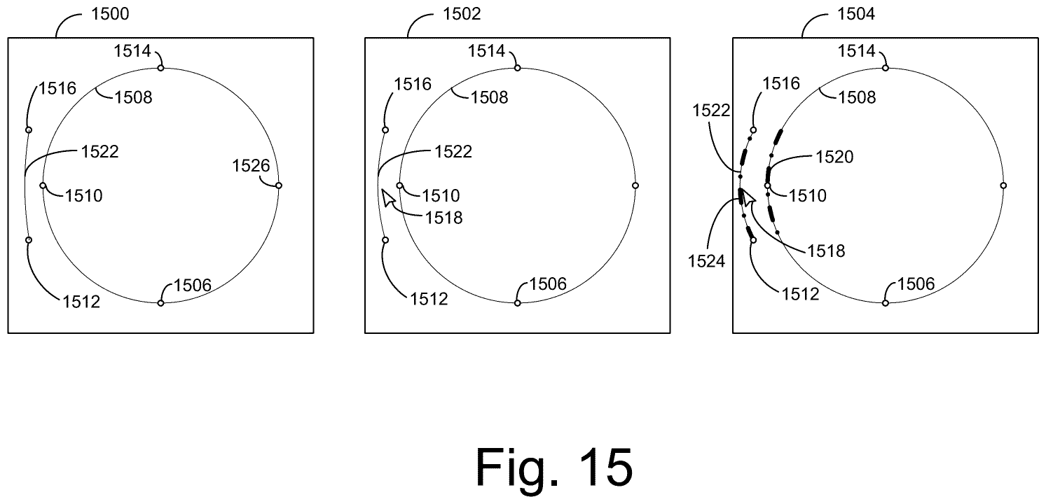

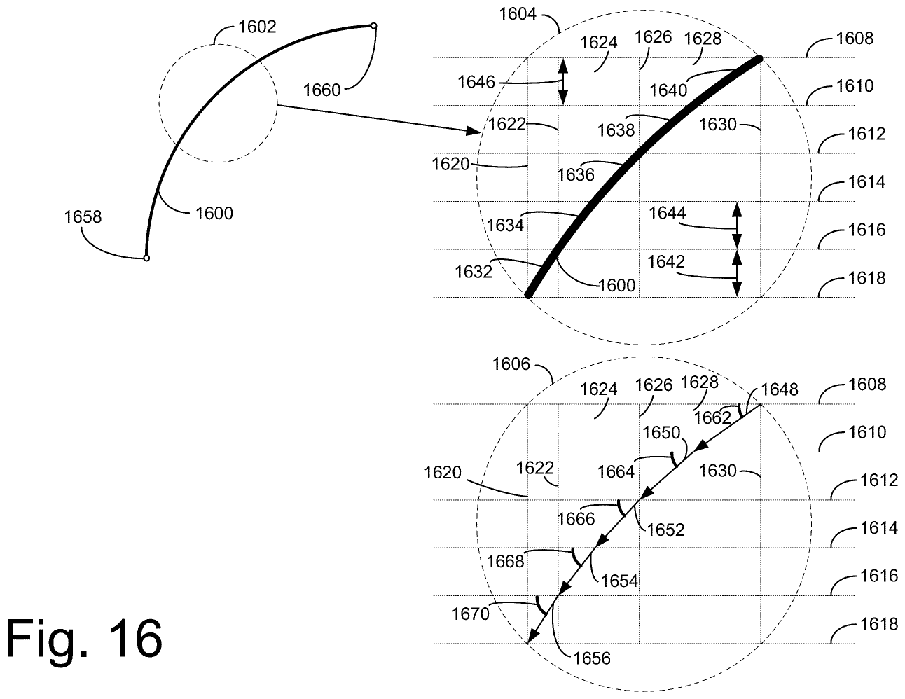

Referring to FIG. 15, various stages of adjustment of another vector curve 1522 are shown. In the stages shown, the vector curve 1522 is selected (e.g., targeted) via user input, such as user input to a computing device by way of a user interface device. The computing device may be similar to, or the same as, the computing device 102 described above with reference to FIG. 1 and is configured to display the vector curve 1522 via a display device. Because the vector curve 1522 is selected, the vector curve 1522 is referred to in this example as a target vector curve 1522.

The vector curve 1522 is shown along with vector curve 1508, which is referred to as a reference vector curve. The target vector curve 1522 and the reference vector curve 1508 are displayed by a digital image editing system, such as the digital image editing system 130 described above with reference to FIG. 1, via a display device, such as the display device 106 described above with reference to FIG. 1.

The target vector curve 1522 includes a first vertex 1512 and a second vertex 1516. In the example shown, the target vector curve 1522 is an open vector curve. In particular, the target vector curve 1522 does not form a closed shape (e.g., closed path). The first vertex 1512 is a beginning vertex of the target vector curve 1522, and the second vertex 1516 is an end vertex of the target vector curve 1522. As the target vector curve 1522 is an open curve including two vertices, the target vector curve 1522 is a single Bezier curve.

The reference vector curve 1508 includes a plurality of Bezier curves defined by a first vertex 1506, a second vertex 1510, a third vertex 1514, and a fourth vertex 1526. In the example shown, the Bezier curves of the reference vector curve 1508 are connected and form a closed shape. In some examples, the first vertex 1506 is the beginning vertex of the reference vector curve 1508 and the fourth vertex 1526 is the end vertex of the reference vector curve 1508. However, in other examples, a different vertex of the reference vector curve 1508, such as second vertex 1510, is the beginning vertex of the reference vector curve 1508, and a different vertex of the reference vector curve 1508, such as third vertex 1514, is the end vertex of the reference vector curve 1508.

Inset 1500 shows a first stage of adjustment of the target vector curve 1522, inset 1502 shows a second stage of adjustment of the target vector curve 1522, and inset 1504 shows a third stage of adjustment of the target vector curve 1522.

In the first stage shown by inset 1500, the target vector curve 1522 is configured with a first curvature. The first curvature is not within a tolerance of the curvature of the reference vector curve 1508. In some examples, the tolerance of the curvature of the reference vector curve 1508 is similar to the examples described above.

Because the first curvature is not within the tolerance of the curvature of the reference vector curve 1508, the curvature system does not display curve guides, such as target curve guides and/or reference curve guides (similar to the examples described above), at the target vector curve 1522 or the reference vector curve 1508. However, in some examples, the curvature system displays curve guides at the target vector curve 1522 and reference vector curve 1508 and updates the appearance of the curve guides based on whether the curvature of the target vector curve 1522 is within the tolerance of the curvature of the reference vector curve 1508. As one example, during conditions in which the curvature of the target vector curve 1522 is not within the tolerance, the curve guides have a first appearance including a first color, first patterning, etc., and during conditions in which the curvature of the target vector curve 1522 is within the tolerance, the curve guides have a second appearance including a second color, a second patterning, etc.

In the second stage shown by inset 1502, the curvature of the target vector curve 1522 has been adjusted via user input. In some examples the user input user interaction with the target vector curve 1522 through a user interface device such as a mouse, trackpad, etc., with the user interface device controlling a position of cursor 1518. However, the adjusted curvature is not within the tolerance of the curvature of the reference vector curve 1508, and the curvature system does not display the curve guides at the target vector curve 1522 or the reference vector curve 1508.

In the third stage shown by inset 1504, the curvature of the target vector curve 1522 has been further adjusted responsive to user input. The adjusted curvature of the target vector curve 1522 is within the tolerance of the curvature of the reference vector curve 1508 in the third stage, and as a result, the curvature system displays target curve guide 1524 at target vector curve 1522 and reference curve guide 1520 at reference vector curve 1508. The target curve guide 1524 indicates an edited curvature of the target vector curve 1522 based on the curvature of the reference vector curve 1508, and the reference curve guide 1520 is displayed for easier visual comparison of the edited curvature with the curvature of the reference vector curve 1508.

It should be appreciated that although the curve guides are shown in the third stage and are not shown in the first stage or the second stage, the curvature system compares the curvature of the target vector curve 1522 to the curvature of the reference vector curve 1508 throughout each stage. In an example, comparing the curvatures includes comparing a curve signature of the target vector curve 1522 to a curve signature of the reference vector curve 1508, and each time the curvature of the target vector curve 1522 is adjusted, the curvature system updates the curve signature of the target vector curve 1522 based on the adjusted curvature of the target vector curve 1522 and compares the updated curve signature of the target vector curve 1522 to the curve signature of the reference vector curve 1508. The curvature system thus determines whether the curvature of the target vector curve 1522 is within the tolerance of the curvature of the reference vector curve 1508.

In the example shown, although the target vector curve 1522 is an open vector curve and the reference vector curve 1508 forms a closed shape, the curvature system compares the curvature of the target vector curve 1522 to the curvature of the reference vector curve 1508. In an example, as described above, comparing the curvature of the target vector curve 1522 to the curvature of the reference vector curve 1508 includes comparing the curve signature of the target vector curve 1522 to the curve signature of the reference vector curve 1508.

The curve signature of the reference vector curve 1508 includes a repeating sequence of identifiers, similar to the examples described above, such that the curve signature of the target vector curve 1522 is compared to the curve signature of the reference vector curve 1508 and a sequence of identifiers included by the curve signature of the target vector curve 1522 is matched with an equal (or approximately equal, within the tolerance of the curvature of the reference vector curve 1508) sequence of identifiers within the repeating sequence of the curve signature of the reference vector curve 1508. In particular, because the curve signature of the reference vector curve 1508 includes the repeating sequence of identifiers, a match between the curve signature of the target vector curve 1522 and the curve signature of the reference vector curve 1508 occurs without aligning the sequences based on the beginning vertices of each curve.

For example, although reference vector curve 1508 includes second vertex 1510 arranged vertically between the first vertex 1512 and the second vertex 1516 of the target vector curve 1522, the curvature system determines that the curvature of the target vector curve 1522 is within the tolerance of the curvature of the reference vector curve 1508 (or portion thereof) and the reference curve guide 1520 is displayed extending across the second vertex 1510 of the reference vector curve 1508. The target curve guide 1524 and the reference curve guide 1520 indicate portions of the target vector curve 1522 and the reference vector curve 1508, respectively, that include matching curvature. In particular, the curve guides indicate curvature of the target vector curve 1522 that is within the tolerance of the curvature of the reference vector curve 1508. In this way, the curvature of open vector curves is compared to the curvature of vector curves forming closed shapes, or vice versa, with consistency and reliability.

Referring to FIG. 16, a Bezier curve 1600 is shown. As described above, vector paths often include one or more Bezier curves. According to the systems and procedures described herein, each Bezier curve included by a target vector curve is discretized (e.g., partitioned) into a set of uniformly sampled points describing a plurality of curve segments, and a plurality of angles associated with each Bezier curve is determined. In particular, for each curve segment, a tangent angle or normal angle to the curve segment is determined. Each angle is assigned a respective identifier (e.g., identifier A for angles between 0-5 degrees, identifier B for angles between 6-10 degrees, and so forth), and the identifiers are combined (e.g., concatenated or otherwise aggregated) to form a curve signature describing the curvature of the Bezier curve. Further, the curve signatures of each section of the vector path, such as each Bezier curve of the target vector curve, are combined to form a curve signature of the target vector curve. In some examples, the combination of the curve signatures includes concatenation of the curve signatures. The curve signature of the vector path describes the curvature of the vector path, with the curve signature stored to a non-transitory memory of the computing device. A curve signature of the reference vector curve is generated in a similar way, and the curve signature of the reference vector curve is stored to the non-transitory memory.

In some examples, the Bezier curve 1600 is a portion of a vector curve including multiple Bezier curves, such as Bezier curves connected by shared vertices. In the example shown, the Bezier curve 1600 includes a first vertex 1658, which is a beginning vertex of the Bezier curve 1600, and a second vertex 1660, which is an end vertex of the Bezier curve 1600. In other examples, second vertex 1660 is the beginning vertex and first vertex 1658 is the end vertex. One or both of the vertices include control handles, similar to the control handles described above. The control handles are not shown. In some examples, the Bezier curve 1600 is the target vector curve, and in other examples the Bezier curve 1600 is the reference vector curve. The Bezier curve 1600 is displayed by a digital image editing system, such as the digital image editing system 130 described above with reference to FIG. 1, through a display device, such as the display device 106 described above with reference to FIG. 1. The digital image editing system includes the curvature system 132 described above.

FIG. 16 additionally shows a first enlargement 1604 of a section 1602 of the Bezier curve 1600. Various axes are shown to illustrate the partitioning of the Bezier curve 1600. It should be appreciated that although the partitioning is shown with respect to the section 1602, the entire Bezier curve 1600 is partitioned in a similar way.

The first enlargement 1604 is shown with horizontal axis 1608, horizontal axis 1608, horizontal axis 1610, horizontal axis 1612, horizontal axis 1614, and horizontal axis 1616. The first enlargement 1604 is additionally shown with vertical axis 1620, vertical axis 1622, vertical axis 1624, vertical axis 1626, vertical axis 1628, and vertical axis 1630. Each horizontal axis is parallel to each other horizontal axis, and each vertical axis is parallel to each other vertical axis. Although the horizontal and vertical axes are shown by the first enlargement 1604, the axes are not displayed by the computing device. In particular, the axes are shown for illustrative purposes and do not represent features included within the vector graphic content. Further, although the axes are included to illustrate the partitioning of the Bezier curve 1600, the partitioning is performed as a calculation via the curvature system and does not alter the appearance of the Bezier curve 1600 as displayed by the display device.

In the example shown, the horizontal axes are equally distributed along a vertical span of the Bezier curve 1600, such that each horizontal axis is spaced apart from each adjacent horizontal axis by a same amount, e.g., a same length. In particular, horizontal axis 1608 is spaced apart from adjacent horizontal axis 1610 by length 1646, horizontal axis 1614 is spaced apart from adjacent horizontal axis 1616 by length 1644, and horizontal axis 1616 is spaced apart from adjacent horizontal axis 1618 by length 1642, and each of the length 1646, the length 1644, and the length 1642 is equal (e.g., a same amount of length). In other examples, the vertical axes are equally distributed along a horizontal span of the Bezier curve 1600 such that each vertical axis is spaced apart from each adjacent vertical axis by a same amount.

In the enlargement 1604, a plurality of segments of the Bezier curve 1600 are shown, where each segment is enclosed by a corresponding pair of adjacent horizontal axes and a corresponding pair of adjacent vertical axes. In particular, enlargement 1604 shows curve segment 1632 bounded by horizontal axis 1616, horizontal axis 1618, vertical axis 1620, and vertical axis 1622, curve segment 1634 bounded by horizontal axis 1614, horizontal axis 1616, vertical axis 1622, and vertical axis 1624, curve segment 1636 bounded by horizontal axis 1612, horizontal axis 1614, vertical axis 1624, and vertical axis 1626, curve segment 1638 bounded by horizontal axis 1610, horizontal axis 1612, vertical axis 1626, and vertical axis 1628, and curve segment 1640 bounded by horizontal axis 1608, horizontal axis 1610, vertical axis 1628, and vertical axis 1630.

The curvature system determines an angle for each segment of the Bezier curve 1600, and each angle is associated with an identifier. The identifiers are combined to form a curve signature of the Bezier curve 1600, similar to the examples described above. As one example, combining the identifiers includes concatenating the identifiers in a sequence of the curve segments, e.g., with a first identifier associated with segment 1632 appearing in the curve signature immediately prior to a second identifier associated with curve segment 1634 with no other identifiers between, with the second identifier appearing in the curve signature immediately prior to a third identifier associated with curve segment 1636 with no other identifiers between, and so forth.

As an example, enlargement 1606 shows another view of the horizontal and vertical axes described above with reference to enlargement 1604. The configuration of the axes is the same as described above. Bezier curve 1600 is not shown by enlargement 1606 for clarity of illustration. However, the relationship of the Bezier curve 1600 and the axes is the same as shown by enlargement 1604 and described above.

Enlargement 1606 includes various line segments extending between the intersections of the axes bounding the curve segments described above. In particular, line segment 1648 extends between the intersection of horizontal axis 1608 with vertical axis 1630 and the intersection of horizontal axis 1610 with vertical axis 1628, line segment 1650 extends between the intersection of horizontal axis 1610 with vertical axis 1628 and the intersection of horizontal axis 1612 with vertical axis 1626, line segment 1652 extends between the intersection of horizontal axis 1612 with vertical axis 1626 and the intersection of horizontal axis 1614 with vertical axis 1624, line segment 1654 extends between the intersection of horizontal axis 1614 with vertical axis 1624 and the intersection of horizontal axis 1616 with vertical axis 1622, and line segment 1656 extends between the intersection of horizontal axis 1616 with vertical axis 1622 and the intersection of adjacent horizontal axis 1618 with vertical axis 1620.

Line segment 1648 is therefore bound by the same axes by which curve segment 1640 is bound, line segment 1650 is bound by the same axes by which curve segment 1638 is bound, line segment 1652 is bound by the same axes by which curve segment curve segment 1636 is bound, line segment 1654 is bound by the same axes by which curve segment 1634 is bound, and line segment 1656 is bound by the same axes by which curve segment 1632 is bound.

The curvature system calculates a plurality of angles based on the partitioning of the Bezier curve 1600. For example, the curvature system determines a first angle 1662 between line segment 1648 and horizontal axis 1608, a second angle 1664 between line segment 1650 and horizontal axis 1610, a third angle 1666 between line segment 1652 and horizontal axis 1612, a fourth angle 1668 between line segment 1654 and horizontal axis 1614, and a fifth angle 1670 between line segment 1656 and horizontal axis 1616. Each of the angles is associated with the respective curve segments shown by enlargement 1604 and described above. In particular, first angle 1662 is associated with curve segment 1640, second angle 1664 is associated with curve segment 1638, third angle 1666 is associated with curve segment 1636, fourth angle 1668 is associated with curve segment 1634, and fifth angle 1670 is associated with curve segment 1632, and a sequence of the angles is equal to a sequence of the curve segments in some examples. In this configuration, the curvature system generates a curve signature of the Bezier curve 1600 using the determined angles by assigning an indicator to each angle and combining the indicators in the sequence of the angles and the curve segments. The curve signature thus indicates the curvature of the Bezier curve 1600.

In some examples, the angles are angles tangent to the curve segments, as in the example shown. In other examples, the angles are normal to the curve segments (e.g., orthogonal to the tangent angles).

The line segments and angles described above are computed (e.g., calculated) by the curvature system without altering the appearance of the Bezier curve 1600, or the vector path including the Bezier curve 1600 in examples in which the Bezier curve 1600 forms a portion of a larger vector path. In particular, the curvature system performs the partitioning of the Bezier curve 1600 and the determination of the angles as a calculation, without displaying the angles, line segments, etc. via the display device and without modifying the shape of the Bezier curve 1600. As one example, the partitioning is performed by the curvature system via a partitioning calculation, where an input of the partitioning calculation includes parameters of the Bezier curve 1600 such as a length, vertex position, etc. of the Bezier curve 1600, and an output of the partitioning calculation includes parameters of the curve segments of the Bezier curve 1600 such as a beginning position and end position of each curve segment, a length of each curve segment, etc. Although the partitioning is described with reference to Bezier curve 1600, vector curves including multiple Bezier curves are partitioned in a similar way.

The curvature system generates the curve signature of the Bezier curve 1600 based on the angles (e.g., by generating the curve signature as a sequence of identifiers based on the angles as described above) without any modification of the Bezier curve 1600. The curve signature is used to compare the curvature of the Bezier curve 1600 to a curvature of other vector curves within the digital image including the curves as described herein. In another example, the Bezier curve 1600 is included as a portion of another vector curve, and the curve signature of the Bezier curve 1600 forms a portion of the curve signature of the vector curve including the Bezier curve 1600. The curvature system compares the curve signature of the vector curve including the Bezier curve 1600 to one or more reference vector curves to determine similarity between the curves. During conditions in which the Bezier curve 1600 is not included by another vector curve, the Bezier curve 1600 itself is selectable as the target vector curve, and during conditions in which the Bezier curve 1600 is included by another vector curve, the vector curve including the Bezier curve 1600 is selectable as the target vector curve. Thus, although in some examples Bezier curve 1600 is included as a portion of another vector curve configurable to be selected as the target vector curve, in some examples Bezier curve 1600 is a vector curve with no other vertices or connections and is configurable to be selected as the target vector curve.

The partitioning of the target vector curve and the partitioning of the reference vector curve is performed without altering the appearance of the target vector curve and the reference vector curve within the digital image including the curves.

Although in the example shown by FIG. 16 the Bezier curve 1600 is partitioned into a plurality of curve segments each having an equal length in the vertical direction, other examples support partitioning a curve into a plurality of curve segments each having an equal length in the direction of the curvature of the curve. For example, in some instances the Bezier curve 1600 is partitioned into a plurality of curve segments similar to the curve segment 1632, curve segment 1634, curve segment 1636, curve segment 1638, and curve segment 1640, but with a length of each curve segment in the direction of the curvature of the Bezier curve 1600 being equal to a length of each other curve segment in the direction of the curvature. Thus, in some instances, the partitioning of the curve includes determining a plurality of curve segments of the curve each having a same length, e.g., arcuate length, along the curve instead of a same length in the horizontal direction or a same length in the vertical direction.

Referring generally to the target vector curve and reference vector curve as described herein, in some examples, the curvature of the target vector curve (which in some examples includes the Bezier curve 1600, and in other examples is a Bezier curve such as the Bezier curve 1600 not connected to other Bezier curves) matches the curvature of the reference vector curve, but other characteristics of the target vector curve and/or the reference vector curve are different. In one example, the target vector curve and the reference vector curve are in different orientations relative to each other, e.g., the target vector curve is in a rotated orientation as compared to the reference vector curve.

In another example, the curvature of the target vector curve matches the curvature of the reference vector curve, but the target vector curve and the reference vector curve are at different scales, e.g., different sizes.

In yet another example, the curvature of the target vector curve matches the curvature of the reference vector curve, but a beginning vertex and an end vertex of the target vector curve are reversed relative to a beginning vertex and an end vertex of the reference vector curve.

In yet another example, the curvature of the target vector curve matches the curvature of the reference vector curve, but the target vector curve and/or the reference vector curve are closed shapes and have different beginning and end vertices relative to each other.

In such examples, to compare the curvature of the target vector curve to the curvature of the reference vector curve, each of the target vector curve and the reference vector curve is normalized prior to determining the respective curve signature of each of the curves. The normalization of the target vector curve and the reference vector curve is performed without altering the appearance of the target vector curve and the reference vector curve within the digital image including the curves, e.g., without altering the shape of either of the target vector curve or the reference vector curve. As one example, the normalization is performed by the curvature system via a normalization calculation, where an input of the normalization calculation includes parameters of the target vector curve such as curve length, vertex position, etc., and an output of the normalization calculation includes normalized parameters of the target vector curve. A similar calculation is performed for normalization of the reference vector curve. The curvature system stores the normalized parameters of the target vector curve and the normalized parameters of the reference vector curve in memory (e.g., non-transitory memory) and determines the curvature signatures of the target vector curve and the reference vector curve based on the normalized parameters.

The normalized parameters include a normalized size of the vector curve, and the normalized size of each vector curve is equal such that each vector curve has a same normalized size. As one example, a first vector curve (e.g., the target vector curve) has an x-length of 240 points and a y-length of 320 points. The x-length refers to a length in the horizontal direction, parallel to an x-axis defined by the digital image editing system, and the y-length refers to a length in the vertical direction, parallel to a y-axis defined by the digital image editing system and perpendicular to the x-axis. A second vector curve (e.g., the reference vector curve) has an x-length of 360 points and ay-length of 480 points. The normalization of the first vector curve includes calculating a normalized size of the first vector curve using a pre-determined normalization size in the x-direction or the y-direction. The x-direction refers to the direction parallel to the x-axis, and the y-direction refers to the direction parallel to the y-axis. As one example, the pre-determined normalization size is 100 points in the y-direction.

In this example, calculating the normalized size of the first vector curve includes scaling the y-length of the first vector curve to 100 points and proportionally scaling the x-length of the first vector curve to 75 points. The scaling of the y-length and the x-length of the first vector curve in this example includes scaling the y-length by a factor equal to 0.3125 and scaling the x-length by the factor equal to 0.3125. Further, in this example, calculating the normalized size of the second vector curve includes scaling the y-length of the second vector curve to 100 points and proportionally scaling the x-length of the second vector curve to 75 points. The scaling of the y-length and the x-length of the second vector curve in this example includes scaling the y-length by a factor equal to 0.208 and scaling the x-length by the factor equal to 0.208. As a result, the normalized size of the first vector curve in the y-direction is equal to the normalized size of the second vector curve in the y-direction.

By determining the normalized size of each of the vector curves and configuring the normalized size of each of the vector curves in the y-direction to be equal, similarity between the curvatures of the vector curves is more easily determined. In this way, vector curves having different scales, resolutions, and/or zoom levels (e.g., magnification) are comparable, even during conditions in which the vector curves have different curve lengths, such as conditions in which an entire length of each vector curve, in the direction of the curve, is different. Although in the example described above the normalized sizes of the vector curves are equal in the y-direction, in other examples the normalized sizes are equal in the x-direction. In one such example, the normalization includes scaling each of the first vector curve and the second vector curve to have normalized sizes in the x-direction equal to 100 points. In the example of Bezier curve 1600 described above with reference to FIG. 16, comparing the curvature of Bezier curve 1600 to the curvature of other vector curves includes calculating the normalized size of Bezier curve 1600 and each of the other vector curves and comparing the curves at the normalized size.

In some examples, comparing the curvatures of the vector curves (e.g., the curvature of the target vector curve and the curvature of the reference vector curve) includes generating a curvature subsequence for each of the vector curves. The curvature subsequence may be referred to herein as a curve subsequence, delta subsequence, and/or curve sub-signature.

For example, as described above, the curvature system generates a curve signature of the target vector curve and a curve signature of the reference vector curve. In generating the curve signature of the target vector curve, the curvature system additionally generates a curve sub-signature of the target vector curve based on differences between adjacent angles of the plurality of angles associated with each Bezier curve of the target vector curve. In particular, as described above, each Bezier curve included by the target vector curve is partitioned into a plurality of curve segments (such as curve segment 1632, curve segment 1634, etc. described above with reference to FIG. 16), and for each curve segment, a tangent angle or normal angle to the curve segment is determined and assigned a respective identifier, with the identifiers being combined to form the curve signature. A sequence (e.g., order) of the identifiers matches a sequence of the curve segments (e.g., adjacent identifiers in the curve signature correspond to adjacent curve segments in the plurality of curve segments), in some examples. The curve sub-signature includes a second set of identifiers, where each identifier of the second set of identifiers is based on a difference between angles determined for a corresponding pair of curve segments of the plurality of curve segments. The curve sub-signature is generated based on the curve signature, in some examples.

In one example, a first angle (e.g., tangent angle) is determined for a first curve segment of the plurality of curve segments, a second angle is determined for a second curve segment of the plurality of curve segments, and a third angle is determined for a third curve segment of the plurality of curve segments, where the second curve segment is spatially adjacent to each of the first curve segment and the third curve segment along a length of the target vector curve such that the second curve segment is between the first curve segment and the third curve segment. One example of the first angle, the second angle, and the third angle includes the angle 1662, the angle 1664, and the angle 1666, respectively, described above with reference to FIG. 16.

The identifiers assigned to the angles of the curve segments are based on a plurality of angle ranges, in some examples. As one example, a first angle range includes angles between 0 degrees and 15 degrees, a second angle range includes angles between 15 degrees and 30 degrees, a third angle range includes angles between 30 degrees and 45 degrees, and so forth. The plurality of identifiers includes a first identifier assigned to angles that are within the first angle range, a second identifier assigned to angles that are within the second angle range, a third identifier assigned to angles that are within the third angle range, etc. In an example, the first angle has a value of 12 degrees, the second angle has a value of 21 degrees, and the third angle has a value of 32 degrees. Determining the identifiers includes sorting the first angle to the first angle range, sorting the second angle the second angle range, and sorting the third angle to the third angle range. As a result, the first identifier is assigned to the first angle, the second identifier is assigned to the second angle, and the third identifier is assigned to the third angle. In this example, the first identifier is referred to as “A”, the second identifier is referred to as “B”, and the third identifier is referred to as “C”. Accordingly, in this configuration, the portion of the curve signature of the target vector curve including identifiers for the angle of the first curve segment, the angle of the second curve segment, and the angle of the third curve segment has the identifier sequence “A-B-C”.

However, the curve sub-signature has a different set of identifiers and a different identifier sequence based on the differences between the angles of the curve segments. Using the example described above, a first difference is calculated between the angle of the first curve segment and the angle of the second curve segment adjacent to the first curve segment. As the first angle has a value of 12 degrees and the second angle has a value of 21 degrees in the example described above, the first difference is equal to 9 degrees.

Further, a second difference is calculated between the angle of the second curve segment and the angle of the third curve segment adjacent to the second curve segment. As the second angle has the value of 21 degrees and the third angle has the value of 32 degrees, the second difference is equal to 11 degrees. The identifiers assigned to the differences between the angles (e.g., the first difference and the second difference) are based on a plurality of difference ranges. In one example, a first difference range includes angle differences having values between 0 and 5, a second angle range includes differences having values between 5 and 10, a third angle range includes differences having values between 10 and 15, and so forth.

In this example, the identifiers assigned to the differences between the angles include a first difference identifier assigned to differences that are within the first difference range, a second difference identifier assigned to differences that are within the second difference range, a third difference identifier assigned to differences that are within the third difference range, etc. The first difference identifier is referred to as “a”, the second difference identifier is referred to as “b”, and the third difference identifier is referred to as “C”. In this configuration, the portion of the curve sub-signature of the target vector curve including difference identifiers for the first difference and the second difference has the sequence “b-c”.

By generating the curve sub-signature of the target vector curve, the curvature of the target vector curve is comparable to the curvature of the reference vector curve even during conditions in which a size and/or orientation of the curves is different. In particular, because the curve sub-signature is generated based on the difference between angles of adjacent curve segments of the target vector curve, the curve sub-signature provides a rotationally invariant and scale invariant indication of the curvature of the target vector curve. The curve sub-signature of the target vector curve while the target vector curve is in a first orientation is equal to the curve sub-signature of the target vector curve while the target vector curve is in a second orientation rotated relative to the first orientation, and additionally, the curve sub-signature of the target vector curve while the target vector curve is scaled by a first amount (e.g., 1.0) is equal to the curve sub-signature of the target vector curve while the target vector curve is scaled by a second amount (e.g., 1.5).

Although the curve signature and the curve sub-signature of the target vector curve are described above, in some examples the curve signature and curve sub-signature of the reference vector curve are generated in a similar way.

In some examples, a curve signature generated by the curvature system, such as the curve signature of the target vector curve, is stored in memory (e.g., non-transitory memory) as a repeating curve signature. In an example, the curvature system generates the curve signature of the target vector curve by partitioning the target vector curve, assigning respective identifiers to each curve segment of the target vector curve, and combining the identifiers (e.g., concatenating the identifiers) as described above. A sequence of the identifiers of the curve signature is duplicated and appended to an end of the curve signature to form the repeating curve signature. A repeating curve signature of the reference vector curve is generated in a similar way.

Comparing the curve signature of the target vector curve to the curve signature of the reference vector curve includes comparing the repeating curve signature of the target vector curve to the repeating curve signature (and/or non-repeating curve signature) of the reference vector curve. In this example, the repeating curve signature of target vector curve is stored in memory as the curve signature of the target vector curve, and the repeating curve signature of reference vector curve is stored in memory as the curve signature of the reference vector curve.

By comparing the repeating curve signature of the target vector curve to the repeating curve signature of the reference vector curve, the curvature system determines similarity between the curvature of the target vector curve and the curvature of the reference vector curve even during conditions in which the target vector curve is a closed vector path and/or the reference vector curve is a closed vector path. “Closed vector path” refers to a vector curve forming a closed shape without open ends.

In some examples, the curve signature generated by the curvature system, such as the curve signature of the target vector curve, is stored in memory (e.g., non-transitory memory) as a reversed curve signature. As an example, the curvature system generates the curve signature of the target vector curve by partitioning the target vector curve, assigning respective identifiers to each curve segment of the target vector curve, and combining the identifiers (e.g., concatenating the identifiers) as described above. The reversed curve signature of the target vector curve is stored in memory as a portion of the curve signature of the target vector curve (e.g., appended to the curve signature of the target vector curve). A reversed curve signature of the reference vector curve is generated in a similar way. In some examples, comparing the curve signature of the target vector curve to the curve signature of the reference vector curve includes comparing the reversed curve signature of the target vector curve to the reversed curve signature (and/or non-reversed curve signature) of the reference vector curve.

Thus, in some examples, the curve signature of the target vector curve includes the reversed sequence of identifiers forming the reversed curve signature, the repeating sequence of identifiers forming the repeating curve signature, and/or the curve subsequence indicating the differences between angles of adjacent curve segments identified via the partitioning. As a result, comparison of the curvature of the target vector curve to the curvature of one or more reference vector curves is provided even during conditions in which the target vector curve and the one or more reference vector curves are in different orientations, are different sizes, are closed or opened curves, are mirror symmetrical, etc.

In some examples, determining the curvature of a vector curve such as the target vector curve or the reference vector curve is representable as:

```
input: a vector curve S
output: a curve signature
begin
  declare sequence of identifiers D ← ϕ
  foreach curve in S do
    normalize curve
    declare set of sampled points P ← ϕ
    sample curve into point set P
    declare identifier sequence M ← ϕ
    foreach point in P do
      compute tangent angle to curve at point
      append identifier for angle into M
    end foreach
  end foreach
  Replicate M by double encoding if curve is a
  closed curve
  Remove adjacent duplicates from M
  foreach adjacent identifier in M do
    compute delta ← distance between pair.second
    and pair.first
  insert identifier for delta into D
  end foreach
  return D
end
```

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example System and Device

FIG. 17 illustrates an example system 1700 that includes an example computing device that is representative of one or more computing systems and/or devices that are usable to implement the various techniques described herein. This is illustrated through inclusion of the digital image editing system 130 including curvature system 132. The computing device 1702 includes, for example, a server of a service provider, a device associated with a client (e.g., a client device), an on-chip system, and/or any other suitable computing device or computing system.

The example computing device 1702 as illustrated includes a processing system 1704, one or more computer-readable media 1706, and one or more I/O interfaces 1708 that are communicatively coupled, one to another. Although not shown, the computing device 1702 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1704 is representative of functionality to perform one or more operations using hardware. Accordingly, the processing system 1704 is illustrated as including hardware elements 1710 that are configured as processors, functional blocks, and so forth. This includes example implementations in hardware as a system specific integrated circuit or other logic device formed using one or more semiconductors. The hardware elements 1710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1706 is illustrated as including memory/storage 1712. The memory/storage 1712 represents memory/storage capacity associated with one or more computer-readable media. In one example, the memory/storage 1712 includes volatile media (such as random access memory (RAM)) and/or nonvolatile media (such as read only memory (ROM), Flash memory, optical disks, magnetic disks, and so forth). In another example, the memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways as further described below.

Input/output interface(s) 1708 are representative of functionality to allow user input to enter commands and information to computing device 1702, and also allow information to be presented and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The one-or-more computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, a system-specific integrated circuit (ASIC), a field-programmable gate array (FPGA), a complex programmable logic device (CPLD), and other implementations in silicon or other hardware. In this context, hardware operates as a computing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1710. For example, the computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing system 1704. The instructions and/or functions are executable/operable by one or more articles of manufacture (for example, one or more computing devices 1702 and/or processing systems 1704) to implement techniques, modules, and examples described herein.

The techniques described herein are supportable by various configurations of the computing device 1702 and are not limited to the specific examples of the techniques described herein. This functionality is also implementable entirely or partially through use of a distributed system, such as over a “cloud” 614 as described below.

The cloud 1714 includes and/or is representative of a platform 1716 for resources 1718. The platform 1716 abstracts underlying functionality of hardware (e.g., servers) and software resources of the cloud 1714. For example, the resources 1718 include systems and/or data that are utilized while computer processing is executed on servers that are remote from the computing device 1702. In some examples, the resources 1718 also include services provided over the Internet and/or through a subscriber network, such as a cellular or Wi-Fi network.

The platform 1716 abstracts the resources 1718 and functions to connect the computing device 1702 with other computing devices. In some examples, the platform 1716 also serves to abstract scaling of resources to provide a corresponding level of scale to encountered demand for the resources that are implemented via the platform. Accordingly, in an interconnected device embodiment, implementation of functionality described herein is distributable throughout the system 1700. For example, the functionality is implementable in part on the computing device 1702 as well as via the platform 1716 that abstracts the functionality of the cloud 1714.

### CONCLUSION

Although implementations of systems and procedures for generating surrogate curvatures for assisted vector drawings have been described in language specific to structural features and/or methods, it is to be understood that the appended claims are not necessarily limited to the specific features or methods described. Rather, the specific features and methods are disclosed as example implementations of systems and procedures for generating surrogate curvatures for assisted vector drawings, and other equivalent features and methods are intended to be within the scope of the appended claims. Further, various different examples are described and it is to be appreciated that each described example is implementable independently or in connection with one or more other described examples.

What is claimed is:

1. A method, comprising:
acquiring, by a computing device, a target vector curve;
generating, by the computing device, a curve signature defining curvature of the target vector curve and a curve signature defining curvature of a reference vector curve;
comparing, by the computing device, the curve signature of the target vector curve to the curve signature of the reference vector curve;
determining, by the computing device based on the comparing, the curvature of the target vector curve is within a threshold tolerance of the curvature of the reference vector curve; and
generating, by the computing device, an edited curvature of the target vector curve based on the curvature of the reference vector curve.

2. The method of claim 1, further comprising displaying, by the computing device, the edited curvature of the target vector curve as a target curve guide at a display device.

3. The method of claim 2, further comprising displaying, by the computing device, a reference curve guide at the reference vector curve at the display device, where a curvature of the target curve guide is equal to a curvature of the reference curve guide.

4. The method of claim 3, further comprising:
displaying, by the computing device, a user confirmation prompt with the target curve guide and the reference curve guide; and
responsive to a user confirmation input to the user confirmation prompt via a user interface device, replacing, by the computing device, the curvature of the target vector curve with the edited curvature.

5. The method of claim 1, further comprising adjusting, by the computing device, the curvature of the target vector curve to the edited curvature.

6. The method of claim 1, wherein the curve signature of the reference vector curve includes a first sequence of identifiers indicating the curvature of the reference vector curve and the curve signature of the target vector curve includes a second sequence of identifiers indicating the curvature of the target vector curve.

7. The method of claim 6, wherein comparing, by the computing device, the curve signature of the target vector curve to the curve signature of the reference vector curve includes determining a difference between the second sequence of identifiers and the first sequence of identifiers.

8. The method of claim 6, further comprising:
generating, by the computing device, the curve signature of the target vector curve by:
partitioning the target vector curve into a first plurality of curve segments;
assigning respective identifiers to each curve segment of the first plurality of curve segments; and
combining the identifiers assigned to the curve segments of the first plurality of curve segments to form the first sequence of identifiers; and
generating, by the computing device, the curve signature of the reference vector curve by:
partitioning the reference vector curve into a second plurality of curve segments;
assigning respective identifiers to each curve segment of the second plurality of curve segments; and
combining the identifiers assigned to the curve segments of the second plurality of curve segments to form the second sequence of identifiers.

9. The method of claim 8, wherein:
each identifier of the first sequence of identifiers corresponds to a respective angle of a respective curve segment of the first plurality of curve segments, and
each identifier of the second sequence of identifiers corresponds to a respective angle of a respective curve segment of the second plurality of curve segments.

10. The method of claim 1, further comprising determining, by the computing device, the reference vector curve from one or more candidate reference vector curves based on a length between each candidate reference vector curve and the target vector curve.

11. The method of claim 1, wherein the tolerance of the curvature of the reference vector curve is a range of curvatures centered around the curvature of the reference vector curve.

12. A method, comprising:
determining, by a computing device, a curvature signature of a reference vector curve within a computer graphics environment;
determining, by the computing device, a curvature signature of a target vector curve;
determining, by the computing device, a difference between the curvature signature of the reference vector curve and the curvature signature of the target vector curve; and
generating, by the computing device, an edited curvature to be applied to the target vector curve based on the difference between the curvature signature of the reference vector curve and the curvature signature of the target vector curve.

13. The method of claim 12, further comprising adjusting, by the computing device, a curvature of the target vector curve by applying the edited curvature to the target vector curve responsive to a user confirmation input via an input device.

14. The method of claim 12, further comprising:
determining, by the computing device, a respective curvature signature for each other vector curve within the computer graphics environment, where the target vector curve, the reference vector curve, and each other vector curve within the computer graphics environment are cubic or quadratic Bezier vector curves; and
comparing, by the computing device, the curvature signature of the target vector curve to the respective curvature signature of each other vector curve within the computer graphics environment.

15. The method of claim 12, wherein determining, by the computing device, the curvature signature of the reference vector curve includes partitioning the reference vector curve to a plurality of curve sections, determining a respective angle for each curve section of the plurality of curve sections, generating a respective identifier for the respective angle of each curve section of the plurality of curve sections, and aggregating each respective identifier in a sequence of the curve sections of the plurality of curve sections.

16. The method of claim 15, wherein:
determining the respective angle for each curve section of the plurality of curve sections includes determining a tangent angle or a normal angle of each curve section; and
generating the respective identifier for the respective angle of each curve section includes sorting the respective angle to one of a plurality of angle ranges and generating the respective identifier based on the sorting.

17. The method of claim 15, wherein:
determining, by the computing device, the curvature signature of the reference vector curve includes determining a curvature delta sub-signature of the reference vector curve based on a difference between the respective angles of adjacent curve sections of the plurality of curve sections; and
determining, by the computing device, the difference between the curvature signature of the reference vector curve and the curvature signature of the target vector curve includes determining a difference between the curvature delta sub-signature of the reference vector curve and a curvature delta sub-signature of the target vector curve.

18. The method of claim 12, wherein the determining, by the computing device, the curvature signature of the target vector curve includes generating a normalization of the target vector curve based on the reference vector curve and determining the curvature signature of the target vector curve based on the generated normalization of the target vector curve.

19. One-or-more computer-readable storage media storing instructions that, responsive to execution by a computing device, causes the computing device to perform operations including:
acquiring a target vector curve;
comparing a curvature of the target vector curve to a curvature of a reference vector curve using respective signatures describing sequences of text; and
responsive to the curvature of the target vector curve being within a tolerance of the curvature of the reference vector curve, generating an edited curvature of the target vector curve based on the curvature of the reference vector curve.

20. The one-or-more computer-readable storage media of claim 19, further comprising instructions stored by the one-or-more computer-readable storage media that, responsive to execution by the computing device, causes the computing device to perform operations including:
displaying, by the computing device, the edited curvature of the target vector curve as a target curve guide at a display device; and
displaying, by the computing device, a reference curve guide at the reference vector curve at the display device, where a curvature of the target curve guide is equal to a curvature of the reference curve guide.
